(19) United States
(12) Patent Application Publication
(10) Pub. No.: US 2024/0335784 A1
(43) Pub. Date: Oct. 10, 2024

(54) SORBENTS, SYSTEMS INCLUDING SORBENTS, AND METHODS USING THE SORBENTS

(71) Applicants: Georgia Tech Research Corporation, Atlanta, GA (US); Global Thermostat Operations, LLC, Brighton, CO (US)

(72) Inventors: Christopher W. Jones, Atlanta, GA (US); Cornelia Rosu, Bear, DE (US); Miles A. Sakwa-Novak, Atlanta, GA (US); Cassandra Hertz, Aurora, CO (US)

(21) Appl. No.: 18/628,034

(22) Filed: Apr. 5, 2024

Related U.S. Application Data
(60) Provisional application No. 63/457,426, filed on Apr. 6, 2023.

(51) Int. Cl. B01D 53/04; B01J 20/26

(52) U.S. Cl. CPC B01D 53/0438; B01J 20/261; B01D 2253/202; B01D 2253/25; B01D 2257/504; B01D 2258/06; B01D 2259/40088

(57) ABSTRACT

The present disclosure is directed towards sorbents, contactors, methods of using sorbents or contactors to capture CO₂, and systems and devices using the sorbents or contactors to capture CO₂. The methods, systems, contactors, and sorbents of the present disclosure can be advantageous over current technologies since they are relatively more robust and reduce the cost of capturing CO₂, in particular from ambient air.

### CROSS-REFERENCE TO RELATED APPLICATION

This application claims priority to U.S. provisional application entitled “SORBENTS, SYSTEMS INCLUDING SORBENTS, AND METHODS USING THE SORBENTS” having Ser. No. 63/457,426 filed on Apr. 6, 2023, which is entirely incorporated herein by reference.

### BACKGROUND

Carbon dioxide (CO₂) is one of the main greenhouse gases that traps heat in the atmosphere. CO₂ is emitted through human related activities such as transportation, electric power, industry, and agriculture. Some of the larger sources of CO₂ emissions are the result of burning fossil fuels, solid waste, and trees as well as through the manufacture of cement and other materials. One way to decrease the amount of CO₂ in the atmosphere is to capture CO₂ using materials having an affinity for CO₂. There is a need for materials that can effectively capture CO₂.

### SUMMARY

The present disclosure provides for sorbents, contactors, methods of using sorbents or contactors to capture CO₂, and systems and devices using the sorbents or contactors to capture CO₂.

In an aspect, the present disclosure provides for a sorbent comprising: a CO₂-philic phase and a support, wherein the CO₂-philic phase includes a first type of CO₂ binding molecule and a second type of CO₂ binding molecule, wherein the first type of CO₂ binding molecule and the second type of CO₂ binding molecule are different.

In an aspect, the present disclosure provides for a sorbent comprising: a CO₂-philic phase and a support, wherein the CO₂-philic phase includes a first type of CO₂ binding molecule and a second type of CO₂ binding molecule, wherein the first type of CO₂ binding molecule is polypropylenimine, and the second type of CO₂ binding molecule is polyethylenimine.

In an aspect, the present disclosure provides for a contactor, comprising a structure and the sorbent as described above and herein.

In an aspect, the present disclosure provides for a system for capturing CO₂ from a gas, optionally the gas is ambient air, comprising: a first device configured to introduce the gas to the sorbent or contactor as described above and herein to bind CO₂ to the sorbent; a second device configured to heat the sorbent containing bound CO₂ to at least a first temperature to release the CO₂, wherein after being heated the sorbent is regenerated so it absorbs CO₂ from the gas; and a third device configured to collect the released CO₂.

In an aspect, the present disclosure provides for a method of capturing CO₂ from gas optionally the gas is ambient air comprising: introducing the ambient air to the sorbent as described above and herein to bind CO₂ to the sorbent; heating the sorbent to at least a first temperature to controllably release the CO₂; and collecting the CO₂ in a CO₂ collection device.

In an aspect, the present disclosure provides for a system for implementing the methods as provided above and herein.

### BRIEF DESCRIPTION OF DRAWINGS

Further aspects of the present disclosure will be more readily appreciated upon review of the detailed description of its various embodiments, described below, when taken in conjunction with the accompanying drawings.

FIG. 1A shows a schematic of how amine moieties bind CO₂ into the form of a carbamate. FIG. 1B is a schematic of a sorbent system comprised of support and CO₂-philic phase. Together, the support and CO₂-philic phase comprise a sorbent.

FIG. 2 is a schematic of honeycomb monolith contactor comprised of a substrate and a sorbent washcoat.

FIG. 3 is a schematic illustration of the SPISS samples preparation by the two solution processing methods: split batch in liquid (SBL) and split batch dry (SBD).

FIGS. 4A-4D illustrate CO₂ uptake profiles: the SBD-processed SPISS samples under 10% CO₂ stream (FIG. 4A) and 400 ppm CO₂ stream (FIG. 4C); the SBL-processed SPISS samples under 10% CO₂ stream (FIG. 4B) and 400 ppm CO₂ stream (FIG. 4D). The flow rate of CO₂ was 90 mL/min.

FIGS. 5A and 5B illustrate the initial adsorption rates for the SPISS samples extracted from the kinetic curves. The error bars were evaluated by using the statistics platform ANOVA from the Origin 2019 program.

FIGS. 6A-6B illustrate temperature-swing adsorption-desorption profiles recorded under 400 ppm CO₂ conditions: 1 h adsorption 35° C.-10 min desorption 90° C. (20 cycles) for bPEI-SBA-15 SBD (FIG. 6A) and combined 12 h dry adsorption followed by 1 h adsorption 35° C. and 10 min desorption 90° C. (18 cycles) for 50% LPPI-bPEI-SBA-15 SBD (FIG. 6B). All other curves are available in Supplementary Material (FIGS. 16-17). The gas flow rate was 90 mL/min.

FIGS. 7A-7C illustrate the change in mass recorded during dynamic vapor sorption measurements of the SPISS samples (FIG. 7A), water uptake curves measured at 35° C. and 50% relative humidity (FIG. 7B) and initial adsorption rate of water at 35° C. and 50% relative humidity (FIG. 7C). The error bars in (FIG. 7C) were evaluated by the ANOVA statistics platform imbedded in the Origin 2019 program. Additional plotting of the curves in A is available in Supplementary Material, FIGS. 18A and 18B.

FIGS. 8A-8B illustrate CO₂ uptake (FIG. 8A) and amine efficiencies (FIG. 8B) under 400 ppm CO₂, 35° C. and 50% relative humidity for the SPISS samples. The blue points are the values extracted from measurements recorded with the fixed bed set up under dry conditions.

FIGS. 9A-9B illustrates high resolution ¹³C NMR cross-polarization (CP) spectra (FIG. 9A) and high-resolution ¹³C NMR direct-polarization (DP) spectra (FIG. 9B) of the SPISS samples.

FIGS. 10A to 10D illustrate N₂ physisorption isotherms for SPISS samples recorded at 77 K.

FIG. 11 illustrates thermogravimetric traces of 50% organic loading SPISS samples.

FIGS. 12A-12D illustrate full and partial (insets) kinetic curves-amine efficiency values of the 40% (reference)−50% non-blend (FIGS. 12A, 12B) and 40% (reference)−50% blend (C, D) for SBD-processed samples under 10% CO₂ conditions at 35° C. and 90 mL/min CO₂ rate flow. Observation: For non-blend, (FIG. 12A), the 50% sample had a faster initial rate (linear regime of the curve) than the 40% reference sample but for a short time that marked an ample and slow transition to pseudoequilibrium. For the blend (FIG. 12C), the two samples had comparable initial rates and approach to pseudoequilibrium state. The amine efficiency value of both the 50% blends and non-blends was lower than that of their 40% reference samples (FIGS. 12B, 12D).

FIGS. 13A-13D illustrate full and partial (insets) kinetic curves-amine efficiency values of the 40% (reference)−50% non-blend (FIGS. 13A, 13B) and 40% (reference)−50% blend (FIGS. 13C, 13D) for SBL-processed samples under 10% CO₂ conditions at 35° C. and 90 mL/min CO₂ rate flow. Observation: both 40% (reference) and 50% samples of non-blends and blends had similar initial rates (FIGS. 13A, 13C). The 50% LPPI-bPEI-SBA-15 SBL had an earlier approach to pseudoequilibrium than its 40% reference sample. Similarly to SBD samples displayed in FIG. 12 above, the amine efficiency value of both the 50% blends and non-blends was lower than that of their 40% reference samples (FIGS. 13B, 13D).

FIGS. 14A-14D illustrate full and partial (inset) kinetic curves-amine efficiency values of the 40% (reference)−50% non-blend (FIGS. 14A, 14B) and 40% (reference)−50% blend (FIGS. 14C, 14D) for SBD-processed samples under 400 ppm CO₂ conditions at 35° C. and 90 mL/min CO₂ rate flow. Observation: The 50% bPEI-SBA-15 SBD had a markedly higher initial rate and approach to pseudoequilibrium than its 40% reference homolog (FIG. 14A). Both the 40% reference sample and 50% LPPI-bPEI-SBA-5 SBL had similar initial rates. However, the 40% reference sample had a slower approach to pseudoequilibrium. The amine efficiency values for each of the two pairs (FIGS. 14A, 14B and FIGS. 14C and 14D) samples were almost similar.

FIGS. 15A-15D illustrate full and partial (inset) kinetic curves-amine efficiency values of the 40% (reference)−50% non-blend (FIGS. 15A, 15B) and 40% (reference)−50% blend (FIGS. 15C, 15D) for SBL-processed samples under 400 ppm CO₂ conditions at 35° C. and 90 mL/min CO₂ rate flow. Observation: Similarly, to the trend of the non-blend 50% bPEI-SBA-15 SBD sample (FIG. 14), the 50% bPEI-SBA-15 SBL homolog had a significant faster initial rate and approach to pseudoequilibrium than its 40% reference (FIG. 15A). The blend 50% LPPI-bPEI-SBA-15 SBL had also slightly faster initial rate and approach to pseudoequilibrium than its 40% reference (FIG. 15C). The amine efficiency values were similar for the 50% LPPI-bPEI-SBA-15 SBL blend and its 40% reference (FIG. 15D). The amine efficiency of non-blend 50% bPEI-SBA-15 was lower than that of its 40% reference (FIG. 15B).

FIGS. 16A-16D illustrate TSA profiles for the SPISS samples (SBL & SBD) (FIG. 16A) 50% bPEI-SBA-15 SBD, (FIG. 16B) 50% LPPI-bPEI-SBA-15 SBD, (FIG. 16C) 50% bPEI-SBA-15 SBL and (FIG. 16D) 50% LPPI-bPEI-SBA-15 SBL recorded under dry 10% CO₂ (90 mL/min). Adsorption 35° C. & 1 h, desorption 90° C. &10 min.

FIGS. 17A and 17B illustrate TSA profiles for the SPISS samples (FIG. 17A) 50% bPEI-SBA-15 SBL and (FIG. 17B) 50% LPPI-bPEI-SBA-15 SBL recorded under dry 400 ppm CO₂ (90 mL/min). Adsorption 35° C. & 1 h, desorption 90° C. &10 min.

FIGS. 18A and 18B illustrate dynamic vapor sorption traces recorded for 50% organic loading SPISS samples (SBL & SBD).

FIGS. 19A-19B illustrate breakthrough curves for the SPISS samples (FIG. 19A) 50% LPPI-bPEI-SBA-15 SBD and (FIG. 19B) 50% bPEI-SBA-15 SBL recorded by using a custom-built fixed bed set up under dry 400 ppm CO₂ stream (90 mL/min).

FIG. 20 illustrates mass loss curves during exposure of sorbents to diluted air while ramping the temperature from room temperature to 900° C.

FIG. 21 illustrates transient mass change profiles from TGA CO₂ uptake experiments at 400 ppm CO₂ and 30° C. (DAC conditions) in dry and humid (10° C. dew point) conditions.

FIGS. 22A-22D illustrate the extent of oxidation over time of PEI, determined via the differential scanning calorimetry method described herein and discussed in the referenced publication (solid lines, DSC), and via the loss of amine efficiency (datapoints, AE) at (FIG. 22A) 5%, (FIG. 22B) 17%, and (FIG. 22C) 30% O₂ concentration; (FIG. 22D) extent of oxidation with different PEI pore fillings. FIGS. 22A-22D have taken from Nezam et al, ACS Sustainable Chem. Eng., 2021, 9, 8477-8486.

FIG. 23 illustrates the extent of oxidation curves for PEI and PPI/PEI in mesoporous titania tested under 17% O₂, balance N₂ at 137.5° C.

### DETAILED DESCRIPTION

Embodiments of the present disclosure provide for sorbents, contactors, methods of using sorbents or contactors to capture CO₂, and systems and devices using the sorbents or contactors to capture CO₂. The methods, systems, contactors, and sorbents of the present disclosure can be advantageous over current technologies since they are relatively more robust and reduce the cost of capturing CO₂, in particular from ambient air. In an aspect, the present disclosure provides for sorbents having an improved CO₂-philic phase that has a greater resistance to oxidation and a reduced hydrophilicity.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, materials science, mechanical engineering, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by volume, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequences where this is logically possible.

It must be noted that, as used in the specification and the appended claims, the singular forms “a,” “an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### DISCUSSION

The present disclosure provides for sorbents and contactors, methods of using sorbents and contactors to capture CO₂, structures including the sorbent, and systems and devices using sorbents to capture CO₂. The present disclosure is directed to multiple types of sorbents and structures that will be described below and herein.

In an aspect, the present disclosure provides for sorbents that include a CO₂-philic phase and a support. In one aspect, the CO₂-philic phase includes a first type of CO₂ binding molecule and a second type of CO₂ binding molecule. The first type of CO₂ binding molecule and the second type of CO₂ binding molecule are different molecules (e.g., the first type of CO₂ binding molecule can be polypropylenimine and the second type of CO₂ binding molecule can be polyethylenimine). The CO₂-philic phase can be a homogeneous mixture or a heterogeneous mixture. The CO₂ binding molecules contain CO₂ binding moieties. The ratio of the amount of the first type of CO₂ binding molecules to the second type of CO₂ binding molecules can be about 0.0001 to 1 mole of the first type of CO₂ binding molecules to mole of the second type of CO₂ binding molecules or about 0.01 to 0.5 mole of the first type of CO₂ binding molecules to mole of the second type of CO₂ binding molecules or about 0.1 to 1 mole of the first type of CO₂ binding molecules to mole of the second type of CO₂ binding molecules or about 0.1 to 0.5 mole of the first type of CO₂ binding molecules to mole of the second type of CO₂ binding molecules. When the two types of CO₂ binding molecules are combined, an improved CO₂-philic phase is created. In an aspect, when the improved CO₂-philic phase is incorporated into the pores of a porous support material, for example, an effective CO₂ sorbent is formed. Further, the sorbents created with the improved CO₂-philic phase lose less of the capacity to capture CO₂ following oxidative exposures compared to sorbents created without the improvement to the CO₂-philic phase, thereby providing them with longer commercial lifetime. Additionally, the sorbents created with the improved CO₂-philic phase are more hydrophilic and can thereby improve performance of the sorbent in a CO₂ adsorption process compared to sorbents without the improvement.

Although not intending to be bound by theory, the combination of the two types of CO₂ binding molecules allows for the ability to tune the properties of the CO₂-philic phase. For example, a CO₂ binding molecule that has a greater resistance to oxidative degradation, or a CO₂ binding molecule that increases hydrophilicity, or a CO₂ binding molecule that has a greater resistance to oxidative degradation and an increased hydrophilcity can be mixed with a CO₂ binding molecule that has a high CO₂ adsorption capacity, with the aim of imparting the beneficial properties of both CO₂ binding molecules on the CO₂-philic phase to create an overall improved CO₂-philic phase. The amount, type, and mixture quantity of the CO₂ binding molecules can be tuned and changed to achieve the desired properties of the CO₂-philic phase. One advantage with a mixture of two types of CO₂ binding molecules can be realized when the CO₂ adsorption capacity is retained, while improved properties with respect to oxidative stability or hydrophilicity are imparted.

A structured support, also referred to as a formed support or as a structure, refers to a support that has been formed into a structure where the structure is, at standard conditions, a solid body. Supports can also be unstructured, at standard conditions having a powdery consistency. When a support is referred to without mention to a structure, forming, or being formed or structured, it can refer to supports that are either structured or unstructured.

Structured supports can take the form of a homogeneous solid body (i.e., comprised predominantly of support but also containing components that allow it to remain a stable body at standard conditions) or as a coating on a substrate, whereby the substrate has a different composition than the coating and provides the mechanical stability to the coating.

It can be useful to utilize a structured support with a CO₂-philic phase as a contactor in a process for removing CO₂ from a gas stream such as ambient air. Contactors provide a geometry to a CO₂-philic phase such that considerations such as pressure drop, throughput, and/or mass transfer rates can be optimized.

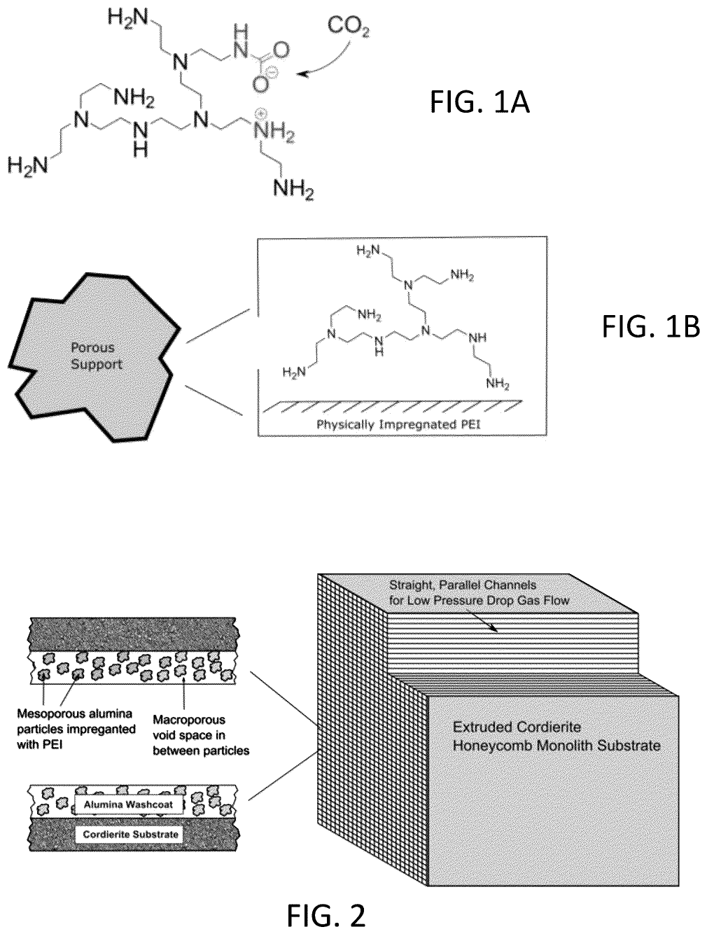

The first type of CO₂ binding molecule and the second type of CO₂ binding molecule can be an amine or an amine polymer. The amine or amine polymer can contain primary amines, secondary amines, tertiary amines, or a mixture of any combination of primary, secondary, and tertiary amines. The amine polymer can be branched, hyperbranched, dendritic, or linear. The CO₂ binding moieties are the amine moieties on the amine molecule or polymer. The amine moieties can interact with CO₂ to form carbamate, carbonate, or bicarbonate species. FIG. 1A is a schematic of how amine moieties bind CO₂ into the form of a carbamate.

Primary amines are defined as having the structure—NH₂R¹, where R¹ is an alkyl group such as CH₂ or CH₃. Secondary amines are defined as having the structure—NHR¹R², where R¹ and R² are independently selected from an alkyl group such as CH₂ or CH₃. Tertiary amines are defined as having the structure —NR¹R²R³, where R¹, R², and R³ are independently selected from an alkyl group such as CH₂ or CH₃.

Linear amine polymers can be defined as containing only primary amines, secondary amines, or both primary and secondary amines. The ratio of secondary to primary amines can be about 0.5 to 10,000. In an aspect, the linear amine polymer can have a molecular weight of about 100 to 100,000 g/mol, about 200 to 30,000 g/mol or about 600 to 5,000 g/mol.

Branched amine polymers can be defined as containing any number of primary, secondary, and tertiary amines, which does not overlap linear amine polymers or dendritic amine polymers. The ratio of primary, secondary, and tertiary can be about 10:80:10 to 60:10:30, about 60:30:10 to 30:50:20, or about 45:45:10 to 35:45:20. As one of skill would understand, the structures of branched amine polymers can vary greatly and can be very complex. In an aspect, the branched amine polymer can have a molecular weight of about 100 to 100,000 g/mol, about 200 to 30,000 g/mol or about 600 to 5,000 g/mol.

Dendritic amine polymers can be defined as containing only primary and tertiary amines, where groups of repeat units are arranged in a manner that is necessarily symmetric in at least one plane through the center (core) of the molecule (e.g., at least one plane can include one plane, two planes, or three planes through the center (core) of the molecule), where each polymer branch is terminated by a primary amine, and where each branching point is a tertiary amine. The core or central linkage is the same as the branching amines (e.g., ethylenimine core and ethylenimine branches, propyleneimine core and propyleneimine branches). The ratio of primary to tertiary can be about 1 to 3. In an aspect, the dendritic amine polymer can have a molecular weight of about 100 to 100,000 g/mol, about 200 to 30,000 g/mol or about 280 to 3,000.

Hyperbranched amine polymers can be defined as having chemical structure resembling dendritic amine polymer, but containing defects in the form of secondary amines (e.g., linear subsections as would exist in a branched polymer), in such a way that provides a random chemical structure instead of a symmetric chemical structure. The hyperbranched amine polymers do not overlap branched amine polymers or dendritic polymers. In a hyperbranched chemical structure, the ratio of primary to secondary to tertiary can be about 65:5:30 to 30:10:60. In an aspect, the hyperbranched amine polymer can have a molecular weight of about 100 to 100,000 g/mol, about 200 to 30,000 g/mol or about 600 to 10,000 g/mol.

In an aspect, linear, hyperbranched and branched amine polymers have secondary amines and dendritic amines do not, which may be advantageous since secondary amines bond strongly to CO₂.

In an aspect, the amine polymer can be polyethylenimine or polypropylenimine, where each can be branched, hyperbranched, dendritic, or linear. In an aspect, the first type of CO₂ binding molecules and the second type of CO₂ can each be linear amine polymers. In an aspect, the first type of CO₂ binding molecules and the second type of CO₂ can each be branched amine polymers. In an aspect, the first type of CO₂ binding molecules and the second type of CO₂ can each be hyperbranched amine polymers. In an aspect, the first type of CO₂ binding molecules and the second type of CO₂ can each be dendritic amine polymers. In an aspect, the first type of CO₂ binding molecules can be a linear amine polymer and the second type of CO₂ can a branched, hyperbranched, or dendritic amine polymer. In an aspect, the first type of CO₂ binding molecules can be a branched amine polymer and the second type of CO₂ can a linear, hyperbranched, or dendritic amine polymer. In an aspect, the first type of CO₂ binding molecules can be a hyperbranched amine polymer and the second type of CO₂ can a linear, branched, or dendritic amine polymer. In an aspect, the first type of CO₂ binding molecules can be a dendritic amine polymer and the second type of CO₂ can a linear, branched, or hyperbranched amine polymer.

In an aspect, the first type of CO₂ binding molecules is polypropylenimine and the second type of CO₂ binding molecules is polyethylenimine, where each can independently be branched, hyperbranched, dendritic, or linear.

Although not intending to be bound by theory, the combination of the two types of CO₂ binding molecules allows for the ability to tune the properties of the CO₂-philic phase. For example, polypropylenimine has been shown to demonstrate greater resistance to oxidative degradation as compared to polyethylenimine. Additionally, the hydrophilicity of the amine polymers is varied. The amount, type, and mixture quantity of the CO₂ binding molecules can be tuned and changed to achieve the desired properties of the CO₂-philic phase.

In an embodiment, the size (e.g., length, molecular weight), amount (e.g., number of distinct amine polymers), and/or type of amine polymer, can be selected based on the desired characteristics of the porous structure (e.g., CO₂ absorption, regenerative properties, oxidative stability, loading, and the like).

In an aspect, it is advantageous to improve the stability of the CO₂-philic phase to process conditions relevant to use of the sorbent in a CO₂ separation process, particularly during sorbent regeneration (process cycles that raise the temperature of the sorbent to remove bound CO₂). It is also advantageous to improve the stability of the CO₂-philic phase to conditions relevant to storage of the sorbents when they are not being utilized in a process or plant. Sorbents that have a CO₂-philic phase with improved stability with respect to process conditions including sorbent regeneration, storage, or both process conditions including sorbent regeneration and storage are valuable.

Evaluating the oxidative stability of materials in environments that contain oxygen and CO₂ is useful due to the fact that during regeneration processes, desorbed CO₂ is present at different concentrations in addition to oxygen at elevated temperatures, and can impact the stability of the material. Separately, evaluating the oxidative stability of materials with oxygen only (air) is a useful way to evaluate the shelf life of a material when it is stored at ambient conditions.

As described above, the CO₂-philic phase can be homogeneous or heterogeneous. When the CO₂-philic phase is heterogeneous, the first type of the CO₂ binding molecules and the second type of CO₂ binding molecules can be present in a variety of ways. For example, the first and second type of the CO₂ binding molecules can be mixed and then applied or incorporated with the structure. In another example, the first and second type of the CO₂ binding molecules can be applied or incorporated separately but once applied or incorporated, the first and second type of the CO₂ binding molecules form the CO₂-philic phase. In an aspect, the first and second type of the CO₂ binding molecules can be applied or incorporated separately to form a layer of the CO₂-philic phase on a support, such as on the surface of pores of the support. In another aspect, the first type of the CO₂ binding molecules can be applied to form a layer on a support (e.g., such as on the surface of pores of the support), and the second type of the CO₂ binding molecules can be applied or incorporated separately onto the layer on the support (e.g., such as on the surface of pores of the support). In another aspect, independent of or used in combination with other aspects such as those described above, the first and second type of the CO₂ binding molecules can be used to form a part of or all of the support, where the CO₂-philic phase functions as described herein. Various combinations are contemplated and are part of the present disclosure. Additional ways in which to apply, use, or incorporate the CO₂-philic phase homogeneously and/or heterogeneously are described herein and below.

As described herein, the sorbent includes the CO₂-philic phase (e.g., homogeneous or heterogeneous combination of the first and second type of the CO₂ binding molecules) and the support. The support includes a surface (e.g., a surface that can be exposed to a gas including CO₂ during regular use and/or that can interact with the CO₂-philic phase). The surface can be the surface of pores and/or other surfaces that the CO₂-philic phase contacts or interacts with.

In an aspect, the CO₂-philic phase (e.g., homogeneous or heterogeneous combination of the first and second type of the CO₂ binding molecules) can be disposed on or within a support to form a sorbent. The CO₂-philic phase can be disposed on the surface of the support, and/or within pores of the support, and/or on exterior surface of a support or any combination thereof. In an aspect, the CO₂-philic phase can be a coating on the surface of the porous material, a monolayer on the surface of the porous material, a self-assembled monolayer on the surface of the porous material, a bulk phase within the pores of the porous material, a coating on the exterior surface of the porous material, and the like.

In an aspect, the support can be made of one or more types of materials such as ceramic, metal, metal oxide, plastic, cellulose, carbon, a zeolite, a metal organic framework (MOF), a porous organic framework (POF), a covenant organic framework (COF), a polymer of intrinsic microporosity (PIM), a polymer, a fibrous cellulose, fiberglass, boron-nitride fiber, and the like. In another aspect, the support can be made of materials that also include the CO₂-philic phase.

The metal oxide support can be selected from cordierite, alumina (e.g., γ-alumina, θ-alumina, δ-alumina), cordierite-α-alumina, silica, aluminosilicates, zirconia, germania, magnesia, titania, hafnia, silicon nitride, zircon mullite, spodumene, alumina-silica magnesia, zircon silicate, sillimanite, magnesium silicates, zircon, petalite, and combinations thereof. In cases where the oxide contains a formal charge, the charge can be balanced by appropriate counter-ions, such as cations of NR₄, Na, K, Ca, Mg, Li, H, Rb, Sr, Ba, Cs or anions including phosphate, phosphite, sulfate, sulfate, nitrate, nitrite, chloride, bromide and the like. The metal oxide can contain dopants such as zirconium, iron, tin, silicon, titanium, magnesium, and combinations thereof. It is known that metal oxides can contain acid, base, and neutral sites on their surfaces and that dopants can alter the amount and strength of acid and base sites on the surfaces.

In an aspect, the polymer support can be a polymer and/or copolymer of polyolefin(s), polyester(s), polyurethane(s), polycarbonate(s), polyetheretherketone(s), polyphenylene oxide(s), polyether sulfone(s), melamine(s), polyamide(s), polyvinylbenzene, polystyrene-divinylbenzene, polyurethane, polyacrylates, polystyrenes, polyacrylonitriles, polyimides, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, and agarose, or combinations thereof.

The support can be porous (e.g., macroporous, mesoporous, microporous, or mixtures thereof (e.g., where a macroporous surface can include mesopores, and/or micropores, within one or more of the macropores, where a mesoporous surface can include micropores, and so on)). In an aspect, the porous structure is mesoporous. The pores can extend through the porous structure or porous layer or only extend to a certain depth. The macropores of the porous structure can have pores having a diameter of about 100 nm to 10,000 nm, a length of about 500 nm to 100,000 nm and a volume of 0.2-1 cc/g. The mesopores of the porous structure can have pores having a diameter of about 5 nm to 100 nm, a length of about 10 nm to 10,000 nm, and a volume of 0.1-2 cc/g. The micropores of the porous structure can have pores having a diameter of about 0.5 to 5 nm, a length of about 0.5 nm to 1000 nm and a volume of about 0.1-1 cc/g.

The support can be porous and have a porosity of at least 90%, at least 85%, at least 80%, at least 75%, at least 70%, at least 65%, at least 60%, or about 60 to 90%. In some embodiments, the support can have a surface area of 1 m²/g or more, 10 m²/g or more, 100 m²/g or more, 150 m²/g or more, 200 m²/g or more, or 250 m²/g or more, 500 m²/g or more, 1000 m²/g or more.

In an embodiment, the CO₂-philic phase (e.g., homogeneous or heterogeneous combination of the first and second type of the CO₂ binding molecules) can be physically impregnated in the internal volume pores of the porous structure and not covalently bonded to the internal surface of the pores of the porous structure, can be grafted (e.g., covalently bonded directly or indirectly) to the internal surface of the pores of the porous structure, or a combination thereof. In an embodiment, the CO₂-philic phase (e.g., homogeneous or heterogeneous combination of the first and second type of the CO₂ binding molecules) can be covalently bonded (e.g., directly to the surface or via a linker group) (optionally only one of the first and second type of CO₂ binding molecules is covalently bonded and the other is not (e.g., the other is physically impregnated)) to the surface of the material, which may include the internal surface of pores for a porous layer or porous structure. In an aspect, the covalent bonding can be achieved using known techniques in the art for bonding sorbents. In regard to the CO₂-philic phase (e.g., homogeneous or heterogeneous combination of the first and second type of the CO₂ binding molecules) being physically impregnated in the pores of the porous structure and not covalently bonded to the internal surface of the pores of the porous structure (e.g., neither the first or second type of CO₂ binding molecules is covalently bonded to the internal surface of the pores), the CO₂-philic phase can otherwise be bonded or attached to the surface (e.g., Van der Waals, ionic bonds or hydrogen bonds). In yet another embodiment, the CO₂-philic phase (e.g., homogeneous or heterogeneous combination of the first and second type of the CO₂ binding molecules) is present in a plurality of pores (internal volume) of the porous structure (“porous structure” can include a structure having pores in its surface or a structure having a porous layer or coating on the surface of the structure (where the structure itself may or may not be porous)), where the CO₂-philic phase has a loading of about 10% to 75% by weight of the support. In regard to the loading, the loading is determined by thermogravimetric analysis (TGA).

In an embodiment, the support can include a surface layer on the surface of the pores of the support that can bond with the CO₂-philic phase (e.g., homogeneous or heterogeneous combination of the first and second type of the CO₂ binding molecules). In an aspect, the surface layer can include organically modified moieties (e.g., alkyl groups, amines, thiols, phosphines, and the like) on the surface (e.g., outside and/or inside surfaces of pores) of the material. In an embodiment, the surface layer can include surface alkyl groups, amines, thiols, phosphines, and the like, that the CO₂-philic phase can directly covalently bond and/or indirectly covalently bond (e.g., covalently bond to a linker covalently bonded to the material). In an embodiment, the surface layer can include an organic polymer having one or more of the following groups: alkyl groups, amines, thiols, phosphines, and the like. In another embodiment, the structure can be a carbon support, where the carbon support can include one or more of the following groups: alkyl groups, amines, thiols, phosphines, and the like.

In an embodiment, the CO₂-philic phase can occupy about 10 to 100% of the mesopore volume of the support or can occupy about 30 to 90% of the mesopore volume of the support or can occupy about 40 to 80% of the mesopore volume of the support or can occupy about 50 to 70% of the mesopore volume of the support.

The process of making a formed support or structure described above and herein can be used to create any of the structures listed in this paragraph and those in the following paragraphs. The sorbent, comprising the CO₂-philic phase (e.g., homogeneous or heterogeneous combination of the first and second type of the CO₂ binding molecules) and the support, can be formed into or applied to a structure. In an aspect, the CO₂-philic phase and the support can form 100% of the structure or less than 100% (e.g., each combination of ranges between about 10%, about 20%, about 30%, about 40%, about 50% and about 60%, about 70%, about 80%, about 90%, about 99% such as about 10-99%, about 10 to 80%, about 10 to 50%, about 50 to 99%, about 50 to 90%, about 50 to 80%), where a sufficient amount of sorbent is on the surface of the structure to absorb the desired amount of CO₂. In an aspect, the structure can be a honeycomb, a laminate sheet, a foam, fibers, gyroids, powder trays, pellets, powder, and the like or a combination of two or more of the foregoing.

In an aspect, the structure can be porous and have a porosity of at least 90%, at least 85%, at least 80%, at least 75%, at least 70%, at least 65%, at least 60%, or about 60 to 90%.

In an aspect, the porosity of the structure can be comprised of macropores, mesopores, and/or micropores. In an aspect, the CO₂-philic phase is predominantly (e.g., about 40 to 100% or about 50 to 90%, or about 60 to 80%) located within the mesopores of the structure.

In an aspect, the structure can be comprised entirely of sorbent or can contain another substrate material such as ceramic, metal, metal oxide, plastic or another material. The structure can be a porous substrate and can also include a porous coating on some or all parts of the porous substrate, where the CO₂-philic phase can be present in the pores of one or both of the porous substrate and the porous coating.

When the structure is comprised entirely of sorbent (e.g., homogeneous or heterogeneous combination of the first and second type of the CO₂ binding molecules), it can be formed by extrusion, molding, 3D printing, and the like, for example. The structure can be formed using support material without the CO₂-philic phase or using the support with the CO₂-philic phase already incorporated. When formed without using the CO₂-philic phase, the CO₂-philic phase can be incorporated into the structure through an impregnation, grafting, or other functionalization technique.

In a particular aspect, the support material can be applied to a substrate as a porous coating (also referred to as a “washcoat”) on the surface of the substrate. In an embodiment, the porous coating can be a foam such as a polymeric foam (e.g., polyurethane foam, a polypropylene foam, a polyester foam, and the like), a metal foam, or a ceramic foam. The porous coating can include a metal-oxide layer (e.g., such as a foam). The metal-oxide layer can be silica or alumina on the surface of the substrate, for example. The porous coating can be present on the surface of the substrate, within the pores or voids of the substrate, or a combination thereof. The porous coating can be about 50 μm to 1500 μm thick and the pores can be of the dimension described above and herein.

In an aspect, the support material, the substrate, and/or the structure can be made of a ceramic substrate such as cordierite, alumina (e.g., γ-alumina, θ-alumina, δ-alumina), cordierite-α-alumina, silica, aluminosilicates, zirconia, germania, magnesia, titania, hafnia, silicon nitride, zircon mullite, spodumene, alumina-silica magnesia, zircon silicate, sillimanite, magnesium silicates, zircon, petalite, and combinations thereof. The metal or metal oxide structure can be aluminum, titanium, stainless steel, a Fe—Cr alloy, or a Cr—Al—Fe alloy. In cases where the oxide contains a formal charge, the charge can be balanced by appropriate counter-ions, such as cations of NR₄, Na, K, Ca, Mg, Li, H, Rb, Sr, Ba, Cs, or anions including phosphate, phosphite, sulfate, sulfate, nitrate, nitrite, chloride, bromide and the like.

In an aspect, the support material, the substrate, and/or the structure can be made of a plastic substrate that can be made of a polymer and/or copolymer of polyolefin(s), polyester(s), polyurethane(s), polycarbonate(s), polyetheretherketone(s), polyphenylene oxide(s), polyether sulfone(s), melamine(s), polyamide(s), polyvinylbenzene, polystyrene-divinylbenzene, polyurethane, polyacrylates, polystyrenes, polyacrylonitriles, polyimides, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, and agarose, or combinations thereof.

In an embodiment, the structure can be a honeycomb structure such as a honeycomb monolith structure that includes channels. The honeycomb structure can have a regular, corrugated structure. The honeycomb monolith structure can have a length and width on the order of cm to m while the thickness can be on the order of mm to cm or more. In an aspect, the honeycomb monolith structure does not have fibrous dimensions. In other words, the honeycomb structure can be a flow-through substrate comprising open channels defined by walls of the channels. The channels can have about 50 to about 900 cells per square inch. The channels can be polygonal (e.g., square, triangular, hexagonal, octagonal) sinusoidal, circular, or the like, in cross-section. Along the length of the channel, the channel length can have a configuration that is straight, zig-zag, skewed, or herringbone in shape. The length of the channel can be 1 mm to 10s or 100s of cm or more. The channels can have walls that are perforated or louvered. In an aspect, the sorbent can be disposed in the pores of the honeycomb structure and/or in the pores of a porous layer on the surface of the honeycomb structure. The honeycomb structure can have a geometric void fraction, otherwise known as the open face area, of between 0.3 to 0.95 or about 0.5 to 0.9.

In an embodiment, the honeycomb structure can comprise an inlet end, an outlet end, and inner channels extending from the inlet end to the outlet end. In some embodiments, the honeycomb comprises a multiplicity of cells extending from the inlet end to the outlet end, the cells being defined by intersecting cell or channel walls.

In an aspect, the honeycomb structure and/or substrate can be ceramic (e.g., of a type produced by Corning under the trademark Celcor®) that can be used with the sorbent in accordance with the principles of the present disclosure. The sorbent can be coated or otherwise immobilized on the inside of the pores of the ceramic honeycomb structure and/or within a porous layer on the surface of the ceramic honeycomb structure. In an aspect, the porous coating can include a metal-oxide layer such as silica or alumina on the surface of the substrate. In an embodiment, the metal-oxide layer can be mesoporous and macroporous. The honeycomb monolith may have a depth of 3 inches to 10 feet or about 3 and 24 inches.

In an aspect, the structure can be laminate sheets. Laminate sheets are structures containing a one-dimensional wall structure, whereby sheets are stacked upon one and other with space in between each sheet such that gas can flow between the sheets.

In an aspect, the structure can be a foam. Foams are structures with an irregular channel structure surrounded by an irregular solid structure. The solid structure is interconnected such that the foam material is self-standing.

In an aspect, the structure can be a plurality of fibers. Fibers are structures with high aspect ratio, and in gas contacting applications can be arranged in a regular array amongst one another when supported at least on one end of the fiber. The fibers can be solid or hollow.

In an aspect, the structure can be a minimal surface solid. Minimal surface solids are structures often used in packing for distillation and absorption systems to increase contact area with a material and a fluid. Minimal surface area solids are geometries that have zero mean surface area and include shapes such as gyroids. Gyroids can be sinusoidal, for example.

In an aspect, the structure can be a powder tray. Powder trays are structures whereby trays hold loose powder or pellets of the sorbent of the present disclosure to form a structured contactor without the material forming a self-standing structure by itself. Powder trays can be arranged in stacked layers to form sheets thereby forming a structure similar to a laminate. These layers can be created using flexible sheets, stiff sheets, or other flat surface that is mounted on a stiff frame structure. Powders are loose, free flowing solids with small characteristic particle diameter such as to provide a powdery consistency. Pellets are beads, balls, or other compacted structures used to provide structure and surface area to sorbents.

In an aspect, the structure can be sorbent particle volumes. Sorbent particle volumes can be contained by one or more walls such that gas can pass through them while keeping the sorbent contained. Sorbent particle volumes can be arranged relative to other sorbent particle volumes such as to approximate a monolith, fiber, or other structured contactor with a solid body.

In an aspect, the sorbent (e.g., structure) in the form of a contactor is an efficient embodiment for an effective method for capturing CO₂ from ambient air or other gas mixtures (e.g., flue gas, exhaust gas, natural gas, or other gasses containing CO₂) because a structured contactor, or a contactor, can be engineered to provide high surface area and low pressure drop for the air processing. Contactors can take the forms described of a honeycomb, a laminate sheet, a foam, fibers, minimal surface solids, powder trays, pellets, powder, and the like or a combination of two or more of the foregoing.

Now having described embodiments of the sorbent and structure, details regarding the systems and methods of the present disclosure are provided. The present disclosure provides for methods of capturing CO₂ from ambient air or other gas mixtures (e.g., flue gas, exhaust gas, natural gas, or other gasses containing CO₂). The method includes introducing the ambient air to the sorbent (e.g., structure), heating the sorbent (e.g., about 10 to 200° C. above the regular sorbent temperature to absorb the CO₂) to at least a first temperature to controllably release the CO₂; and collecting the CO₂ in a CO₂ collection device. The temperature increase in the sorbent can be performed by contacting the sorbent with a gas at elevated temperature, contacting the sorbent with a fluid at an elevated temperature, contacting the sorbent with a heat exchanger with hot fluid or gas running through it, by heating the walls of the container, vessel, or other containment device that contains the sorbent, or by contacting the sorbent with steam (e.g., the steam may be at a temperature between 60 to 200° C., and be saturated or superheated). In an aspect, the method can be implemented using the system described below.

The present disclosure provides for systems and devices for capturing CO₂ from ambient air or other gas mixtures (e.g., flue gas, exhaust gas, natural gas, or other gasses containing CO₂) where removal of CO₂ is important. In general, the system includes a first device configured to introduce the ambient air or other gas mixture to the sorbent or contactor, where the sorbent or contactor includes those described herein. The sorbent is exposed to the ambient air or other gas mixture for a period of time (e.g., hours). In a particular aspect, the sorbent is a honeycomb monolith that has an open face area of between 0.3-0.95. The first device is configured to deliver the ambient air, for example, to the honeycomb monolith at a velocity of between 0.25-10 m/s. After the desired amount of time, a second device configured to heat the sorbent containing bound CO₂ to at least a first temperature to release the CO₂. The second device of the system can operate to desorb CO₂ by the sorbent. The second device can include components to support temperature swing, pressure swing, steam swing, concentration swing, combinations thereof, or other dynamic processes to desorb the CO₂. In an embodiment, the steam swing process can include exposing the sorbent to steam, where the temperature of the steam is about 60° C. to 150° C. and the pressure of the steam is about 0.2 bara to 5 bara. A third device is configured to collect the released CO₂. The system can be operated so that the sorbent absorbs and desorbs the CO₂ in an efficient and cost-effective manner.

The present disclosure includes the following aspects. The aspects are not limiting but rather include various features and combinations of features of the present disclosure.
Aspect 1. A sorbent comprising: a CO₂-philic phase and a support, wherein the CO₂-philic phase includes a first type of CO₂ binding molecule and a second type of CO₂ binding molecule, wherein the first type of CO₂ binding molecule and the second type of CO₂ binding molecule are different.
Aspect 2. The sorbent of aspect 1, wherein the first type of CO₂ binding molecule and the second type of CO₂ binding molecule are independently selected from an amine polymer, optionally where the amine polymer is branched, hyperbranched, dendritic, or linear.
Aspect 3. The sorbent of aspect 2, wherein the first type of CO₂ binding molecule is polypropylenimine, and the second type of CO₂ binding molecule is polyethylenimine.
Aspect 4. The sorbent of aspect 2, wherein the ratio of the amount of the first type of CO₂ binding molecule to the second type of CO₂ binding molecule is about 0.0001 to 1 mole of the first type of CO₂ binding molecule to mole of the second type of CO₂ binding molecule.
Aspect 5. The sorbent of aspect 2, wherein the ratio of the amount of the first type of CO₂ binding molecule to the second type of CO₂ binding molecule is 0.01 to 0.5 mole of the first type of CO₂ binding molecule to mole of the second type of CO₂ binding molecule.
Aspect 6. The sorbent of any one of the aspects provided, wherein the CO₂-philic phase homogeneous.
Aspect 7. The sorbent of any one of the aspects provided, wherein the CO₂-philic phase heterogeneous.
Aspect 8. The sorbent of any one of the aspects provided, wherein the first type of CO₂ binding molecule, the second type of CO₂ binding molecule, or both are physically impregnated into pores of the support, optionally wherein both are physically impregnated into pores of the support.
Aspect 9. The sorbent of any one of the aspects provided, wherein the first type of CO₂ binding molecule, the second type of CO₂ binding molecule, or both are physically impregnated onto the surface of the support, optionally wherein both are physically impregnated onto the surface of the support.
Aspect 10. The sorbent of any one of the aspects provided, wherein the first type of CO₂ binding molecule, the second type of CO₂ binding molecule, or both are covalently bonded to the surface of the support, optionally wherein one of the first type of CO₂ binding molecule and the second type of CO₂ binding molecule is covalently bonded to the surface of the support, optionally wherein both the first type of CO₂ binding molecule and the second type of CO₂ binding molecule are covalently bonded to the surface of the support.
Aspect 11. The sorbent of any one of the aspects provided, wherein the support is ceramic, metal, metal oxide, plastic, cellulose, carbon (e.g., particles), a zeolite, a metal organic framework (MOF), a porous organic framework (POF), a covenant organic framework (COF), polymers of intrinsic microporosity (PIM), a polymer, a fibrous cellulose, fiberglass, or boron-nitride fiber.
Aspect 12. A contactor, comprising a structure and the sorbent of any one of aspect 1 to 11.
Aspect 13. The contactor of aspect 12, wherein the structure is selected from a honeycomb, a laminate sheet, a foam, fibers, gyroids, powder trays, pellets, powder, or a combination of these.
Aspect 14. A system for capturing CO₂ from a gas, optionally the gas is ambient air, comprising: a first device configured to introduce the gas to the sorbent or contactor of any one of aspects 1 to 11 to bind CO₂ to the sorbent; a second device configured to heat the sorbent containing bound CO₂ to at least a first temperature to release the CO₂; and a third device configured to collect the released CO₂.
Aspect 15. The system of aspect 14, wherein after being heated the sorbent is regenerated so it able to absorb CO₂ from the gas.
Aspect 16. The system of any of the aspects provided, wherein the sorbent is in the form of a honeycomb, a laminate sheet, fibers, a minimal surface solid, a foam, pellets, powder trays, a combination thereof.
Aspect 17. The system of any of the aspects provided, wherein the honeycomb has an open face area of between 0.3-0.95.
Aspect 18. The system of any of the aspects provided, wherein the gas approaches the honeycomb at a velocity of between 0.25-10 m/s.
Aspect 19. The system of any of the aspects provided, wherein the system is configured to operate to remove CO₂ from ambient air, where the ambient air has a low concentration of CO₂.
Aspect 20. A method of capturing CO₂ from gas optionally the gas is ambient air comprising: introducing the ambient air to the sorbent of any one of aspects 1 to 11 to bind CO₂ to the sorbent; heating the sorbent to at least a first temperature to controllably release the CO₂; and collecting the CO₂ in a CO₂ collection device.
Aspect 21. The method of any of the aspects provided, wherein heating the sorbent regenerates the sorbent so it is able to absorb CO₂ from ambient air.
Aspect 22. The method of any of the aspects provided, wherein the method is configured to operate to remove CO₂ from ambient air, where the ambient air has a low concentration of CO₂.
Aspect 23. The method of any of the aspects provided, wherein the sorbent is in the form of a honeycomb, a laminate sheet, fibers, a foam, a minimal surface solid, pellets, powder trays, a combination thereof.
Aspect 24. A system for implement the method of any one of aspects 20 to 23.

### EXAMPLES

The removal of CO₂ from ambient air through engineered chemical processes, otherwise known as Direct Air Capture (DAC), is emerging as an important environment technology for the mitigation of climate change. DAC is a technology that can provide negative emissions, removing CO₂ from the atmosphere. However, the current DAC technology is expensive thereby limiting its deployment. Therefore, improvements to DAC technology are needed.

Many DAC technologies rely on solid sorbent materials as a medium to perform the separation of CO₂ from the air. These sorbents are generally applied in temperature swing processes, where at low temperature CO₂ from the air binds to the sites within them, and then at high temperature the CO₂ is released into a concentrated product that can be sequestered or sold as a product. Many DAC sorbents utilize amines to bind CO₂ in this manner. Certain amine types can be effective at binding CO₂ from low concentrations such as that found in the air (400 ppm).

While some amine types are effective at binding CO₂ from ambient air, they slowly oxidize in air from ambient oxygen. This effect is exacerbated in process cycles that raise the temperature of the sorbent to remove bound CO₂, thereby creating accelerated oxidative degradation that reduces the lifetime of the CO₂ sorbents. Therefore, sorbents with improved oxidative stability that are effective at removing CO₂ from ambient air are needed.

Some sorbents used in DAC processes are composite materials, containing a CO₂-philic phase (e.g., homogeneous or heterogeneous combination of the first and second type of the CO₂ binding molecules) that is distributed in or within a solid material that provides it with surface area. The CO₂-philic phase can be grafted to the solid surface, physically impregnated into the pores of the solid material, or physically supported on the surface of the solid material. The CO₂-philic phase of these sorbents can be amines or other molecules that can bind CO₂. In some cases, the amines can be polymeric amines such as polyethylenimine, polypropylenimine, polyallylamine, polyvinylamine, polybutylamine or others. These polymeric amines can be linear, branched, hyperbranched, dendritic, or take the form some other macromolecule. In other cases, the amines can be small molecules such as TEPA, TPTA or others. In other cases, the amines can be aminosilanes. The solid support material can be a metal oxide, carbon, metal, or other structure that can provide ample surface area for the CO₂-philic phase to be deposited to allow for useful CO₂ adsorption and desorption capacities and kinetics. In this way, the solid support material is functionalized with the CO₂-philic phase to create a composite sorbent.

The sorbents can be formed or incorporated into macrostructures, or contactors, to provide advantages in applications such as DAC. Such structures can be honeycomb monoliths, laminate sheets, pellets, or other structures that can provide a high geometric surface area for air or CO₂ containing gasses to efficiently contact the sorbent such that the CO₂ can bind to the sorbent.

The sorbents can be utilized in processes to capture CO₂ from air or a variety of other gas stream such as flue gas, natural gas and others. These processes are known as “CO₂ Capture Processes”. CO₂ capture processes can utilize temperature swing, concentration swing, pressure swing, steam stripping or other swing techniques to remove CO₂ that has been bound the surface of the sorbent.

There has been relatively little development of improved CO₂ sorbents utilizing polyethylenimine, and especially for DAC applications.

Now having described the embodiments of the present disclosure, in general, the following examples describes some additional embodiments of the present disclosure. While embodiments of the present disclosure are described in connection with these examples and the corresponding text and figures, there is no intent to limit embodiments of the present disclosure to these descriptions. On the contrary, the intent is to cover all alternatives, modifications, and equivalents included within the spirit and scope of embodiments of the present disclosure.

FIG. 1B is a schematic of sorbent system comprised of support and CO₂-philic phase. Together, the support and CO₂-philic phase comprise a sorbent. FIG. 1B shows the primary components of the sorbent system. The sorbent system is comprised of a support material and a CO₂-philic phase. In the schematic shown, a single CO₂-philic phase is shown incorporated into a single support. The CO₂-philic phase shown is polyethylenimine (PEI). One known adsorption product of CO₂ and PEI is ammonium carbamate. Mesoporous alumina is shown as a support.

FIG. 2 is a schematic of honeycomb monolith structure comprised of a substrate and a sorbent washcoat. The sorbent washcoat is comprised of a support and a CO₂-philic phase. This example shows a cordierite substrate, an alumina support, and a PEI CO₂-philic phase. FIG. 2 shows one embodiment of a honeycomb monolith contactor. FIG. 2 shows the primary geometrical features of a honeycomb monolith, having straight, flowthrough channels surrounded on all sides by walls. FIG. 2 schematically shows a washcoat applied to the walls, where the washcoat is comprised of sorbent. The sorbent is comprised of a support material and a CO₂-philic phase, such as PEI.

### Example 1

Solid sorbents made of small amine molecules and polyamines infused into mesoporous substrates are promising materials for CO₂ capture technologies. To date, their preparation is mainly based on wet infusion with focus on increasing amine content by varying the structure of the amine sorbent and designing solid substrates of various pore parameters. Less explored in the field are changes in processing to afford efficient CO₂ sorbents. In this study, branched polyethylenimine (bPEI, M_{w}=800 Da) alone and blends with linear polypropylenimine (LPPI, Mₙ=6,700 Da) are infused into solid SBA-15 substrates by a method that varies the solution processing called sequential polymer infusion into solid substrates (SPISS). The reference 40% bPEI-SBA-15 samples are split by two methods: split batch in dry suspension (SBD) and split batch in liquid suspension (SBL). Sequentially, alcoholic 10% of bPEI (non-blends) and 10% of LPPI (blends) solutions are introduced to afford the desired products. Under dry conditions, the resulting 50% bPEI-SBA-15 SBD & SBL sorbents display high CO₂ capacities up to 3.47 mmol CO₂/gₛᵢₒ₂ for simulated flue gas (10% CO₂) and 2.62 mmol CO₂/gₛᵢₒ₂ for direct air capture (DAC, 400 ppm CO₂). Under humid DAC conditions the CO₂ performance is further enhanced with an uptake of 4.62 mmol CO₂/gₛᵢₒ₂ and amine efficiency of 0.22 mmol CO₂/mmol N. Subjected to extended temperature swing adsorption kinetic cycling (20 cycles), the SPISS samples display stable working capacities and retain over 70% (blends) and over 90% (non-blends) of their initial 12 h adsorption performance. LPPI is demonstrated to be an effective water sorption limiting agent using dynamic vapor sorption measurements. Solid state NMR techniques reveal important insights into the dynamics of the amine polymers confined into SBA-15 pores, as impacted by processing conditions. The results indicate that the conformation of the polymers is different depending on the processing method, displaying relatively tight (SBD) and loose (SBL) packing. The simple solution processing approaches presented here show that processing variations may guide the design of solid amine sorbents with desirable properties relevant for integration into CO₂ capture technologies.

The continuous economic development associated with growing industrialization and the rise in the global population has driven growth in energy production and concomitant accumulation of carbon dioxide (CO₂) in the atmosphere. CO₂ is one of the key greenhouse gases linked to climate change,¹ where the main sources contributing to the growth of the atmospheric CO₂ concentration emissions stem from fossil fuel combustion for energy and from chemical processes.² The atmospheric CO₂ concentration reached a record high concentration value of 415 ppm in July of 2021³ and will continue to increase another 10% by 2040² To reduce the most significant negative impacts of anthropogenic CO₂ on climate and, at the same time, meet the goals set by the Paris Agreement of limiting global warming to 1.5° C.,⁴ continued advances and deployments in carbon capture, utilization and sequestration are essential.

Carbon capture and utilization (CCU)⁵ and carbon capture and storage (CCS)^{6, 7} are two of the main ways available to limit the impact of CO₂ on climate change. CCU technologies have recently attracted interest because the captured CO₂ is regarded as a renewable resource.^{8, 9} Processes focused on conversion of CO₂ into sustainable products can potentially complement or supplant the use of conventional petrochemical feedstock.¹⁰ Yet large scale implementation of CCU remains highly challenging due to the thermodynamic stability of CO₂.¹¹ On the other hand, CCS technologies aim to selectively remove CO₂ from various gas streams. These streams include dilute mixtures (5-20% CO₂) such as those from coal, or gas-fired power plants as well as large industrial sources.¹²⁻¹⁶ Conventional, point source capture, in conjunction with a transition to renewable energy as well as deployment of more efficient energy consuming devices all produce a common product referred to as “avoided emissions”. Deployment of these technologies help society slow the pace at which we are making climate change worse.

However, in parallel, we need to try to reverse climate change by removing CO₂ from the atmosphere. Processes focused on CO₂ removal, also referred to as negative emission technologies (NETs), produce a complementary product called “avoided emissions,” as mentioned in the preceding paragraph. Direct air capture (DAC) is an emerging technology that is focused on extracting CO₂ from the ambient air (ultra-dilute CO₂ source).¹⁷ DAC is a negative CO₂ emissions technologyl¹⁸ when it is coupled with carbon sequestration, such as compression of CO₂ to the supercritical state and storage in geological formations (e.g. gas and depleted oil reservoirs, etc.).¹⁹ The large scale deployment of CCS, either from point sources (avoided emissions) or the atmosphere (negative emissions), has been limited by policymakers who view the costs (primarily associated with capture and compression)²⁰ as too high. Therefore, developing processes that reduce the cost of CO₂ capture technologies is an important challenge.²¹⁻²³

Many approaches have been developed for breakthrough cost reductions and one of the most promising is the use of amine-functionalized solid sorbents for adsorption-based CO₂ capture.²⁴⁻²⁶ As a function of the preparation method, amine-based sorbents were divided into three classes.²⁶ Class I sorbents uses wet infusion of amine molecules or amine polymers to incorporate amine moieties into the pores where some amines physically bind to the solid support.^{26, 27} The covalent grafting method is usually used for the class II sorbents where typically aminosilane molecules are chemically bound to the support surface.^{26, 28} Class III sorbents involve covalent grafting of polymeric amines to the support via in situ-polymerization,²⁹ whereas class IV combines the preparation methodologies of the class I and class II sorbents.^{30, 31} To be cost effective, these sorbents must ideally display key properties: high adsorption capacity, fast kinetics, low energy for regeneration (e.g., Cₚ, ΔH_{ads}, etc.), rapid heat transfer and long lifetime.^{17, 32}

To date, engineering of these materials has mainly exploited a growing knowledge of their structure-property relationships. The design space has employed a variety of solid mesoporous supports. The most well-studied are mesoporous silicas (SBA-15, MCM-41, MCM-48, MCF, etc.),^{33, 34} metal-organic frameworks (MOFs)^{35, 36} and γ-alumina.³⁷ The most frequently used amine molecules for infusion into mesoporous substrates (class 1 or 4 sorbents) are small molecules like diethanol amine (DA),²⁸ or tetraethylenepentamine (TEPA)³⁸ as well as low molecular weight polymers or oligomers such as polyallylamine (PAA)³⁹ and branched and linear polyethylenimine (b/LPEI).^{40, 41} Each year, new amine molecules or oligomers/polymers are introduced, with recent examples being branched and linear polypropylenimine (b/LPPI),^{42, 43} polyglycidylamine,⁴⁴ or molecular aryl-alkyl amines⁴⁵. The most researched amine molecules from the above examples are TEPA^{35, 46, 47} and PEI.^{27, 41, 48}

To increase the efficacy of the sorbents, many efforts were dedicated to designing porous supports with different channel geometries, pore size or chemical composition.⁴⁹⁻⁵⁶ These design variations typically targeted maximization of the amine loading and or improvement of gas diffusion through the sorbents, with a goal of increasing the CO₂ adsorption performance without causing significant mass transfer limitations due to pore clogging. One of the most used solid supports in CO₂ adsorption studies is SBA-15. For example, Olea et al. synthesized mesostructured SBA-15 with expanded pores from the most common pore sizes of 6-7 nm to 11-15 nm.⁵⁰ Their 50% PEI and 50% TEPA-infused SBA-15 sorbents showed improved CO₂ adsorption capacity (3.13 and 3.72 mmol CO₂/g) and amine efficiencies (0.33 and 0.37 mmol CO₂/mmol N) at 45° C., 1 bar and pure CO₂. The authors associated the observed enhanced CO₂ performance parameters with the high N content of the samples enabled by the available high pore volume of the modified SBA-15 (1.18 cm³/g). Lashaki and Sayari studied the effect of support pore structure and CO₂ adsorption properties as well.⁵⁴ They concluded that large pore size as well as high intrawall pore volume allow for higher surface amine density and improved amine accessibility reflected by the enhanced adsorptive properties.⁵⁴ A comprehensive list (up to 2017) of PEI-silica-based sorbents is available in the review by Shen et al.⁴¹ All these studies utilized traditional methods of wet infusion and/or grafting of the amine molecules into the supports.

Besides infusion into porous solid supports, other approaches have been used to increase the CO₂ performance PEI. For example, Rim et al. developed a complex system made of PEI-tethered silica nanoparticles with ionic bonds (called NOHM-I-PEI) that were incorporated as liquid-like droplets into a continuous silicone acrylate phase via shear emulsification (NPEI-SIPs).⁵⁷ For 49% NOHM-I-PEI loading, the authors reported CO₂ adsorption values of 3.1 mmol CO₂/g NPEI-SIPs for 15% CO₂ and 1.7 mmol CO₂/g NPEI-SIPs for 400 ppm CO₂ under humid conditions (2.5% H₂O).⁵⁷ In another example, Xu et al. prepared a non-porous hydrogel by crosslinking PEI with triglycidyl trimethylpropane (TTE) called PEI “snow”.⁵⁸ They used ambient air as a source of CO₂ without dehumidification and reported moderate uptakes of 1.19 mmol CO₂/g sorbent and 1.29 mmol CO₂/g sorbent for 1000 and 2000 mL/min flow rates, respectively.⁵⁸ Liu et al. combined wet infusion and chemical crosslinking and synthesized a hyper-crosslinked poly (styrene) resin infused with PEI.⁵⁹ The highest CO₂ uptake value was 3.24 mmol/g at 25° C. under 10% CO₂ stream.⁵⁹ Yoo et al. reported a self-supported polymeric adsorbent entirely made of crosslinked branched PEI.⁶⁰ Crosslinking was achieved by using poly (ethylene glycol) diglycidyl ether via an ice templating approach. The sorbent had high amine efficiency of 0.32 mmol CO₂/mmol N and CO₂ uptake of 2.81 mmol CO₂/g_{sorbent} at 25° C. under 10% CO₂ and 1 bar conditions. This performance was further enhanced to 5.5 mmol CO₂/g_{sorbent} under humid conditions (65% RH).⁶⁰ These examples undertook more complex approaches to preparing amine-based sorbents that may challenge the cost and scale up requirements for an efficient CO₂ capture process. Therefore, simpler processes would be advantageous. In line with this idea, an underexplored approach in the field of CO₂ capture for designing efficient solid amine sorbents is variations in their solution processing that can greatly impact the targeted properties.

This study demonstrates that manipulation of structure-processing-property relationships results in amine-based solid sorbents with enhanced CO₂ adsorption performance. bPEI and blends of bPEI/LPPI infused into SBA-15 composites were prepared by wet infusion and by varying the solution processing, a method denoted as sequential polymer infusion into solid substrates (SPISS). bPEI was sequentially introduced into mesoporous SBA-15 via two methods: split batch in a dry suspension (SBD) and split batch in a liquid suspension (SBL). The CO₂ uptake of the prepared sorbents was explored under both dry and humid conditions for 10% CO₂ (simulated flue gas) as well as 400 ppm CO₂ (DAC) conditions. LPPI was blended with bPEI in a low percentage to test whether its hydrophobic character can limit water uptake and impact adsorption performance. The behavior of the SPISS samples under working conditions was evaluated by extended temperature-swing adsorption-desorption kinetic cycling. Solid state NMR techniques revealed interesting insights about the processing impacts on the morphology of the polymers (bPEI and LPPI) under pore confinement. The study presented here represents an example of harnessing simple solution processing approaches that broaden the design space for polymer-based composites with desirable enhanced CO₂ capture properties.

### Results and Discussion

### Synthesis and Characterization of the SPISS Samples.

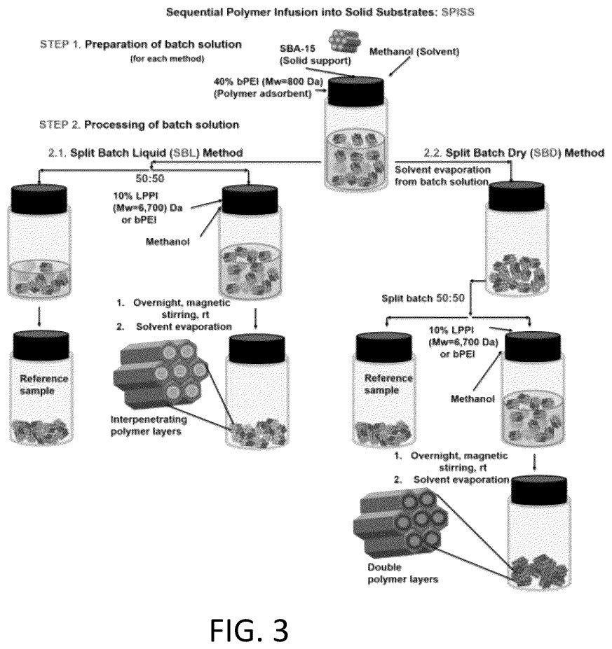

FIG. 3 shows the steps involved in the SPISS sample preparation by the two methods: split batch in liquid (SBL) and split batch dry (SBD). The SPISS processing started with the preparation of a reference batch, 40% bPEI-SBA-15, by wet infusion. For the SBL method, the reference batch was split in the suspension state in a 50:50 ratio. One half was kept as a standard and the other half was combined with (a) 10% bPEI alone or (b) blended with a 10% LPPI, both as premade solutions in methanol. The final batches (a) 50% bPEI-SBA-15 SBL, (b) 50% LPPI-bPEI-SBA-15 SBL and the reference 40% bPEI-SBA-15 were obtained after solvent evaporation. In the SBD method, the reference batch was first dried to a fine powder state. Subsequently, the solid was split 50:50. Again, one half was the standard, and the other half was redispersed in methanol. To the resulting suspension, 10% bPEI-MeOH and/or 10% LPPI-MeOH solutions were introduced following the same steps described for (a) and (b) in the SBL method. These samples were abbreviated: 50% bPEI-SBA-15 SBD and 50% LPPI-bPEI-SBA-15 SBD. For the blended bPEI-LPPI samples, it was hypothesized that the SBL approach will lead to interpenetrating polymer layers at the pore mouth while SBD will lead to polymer domains separated in layers.

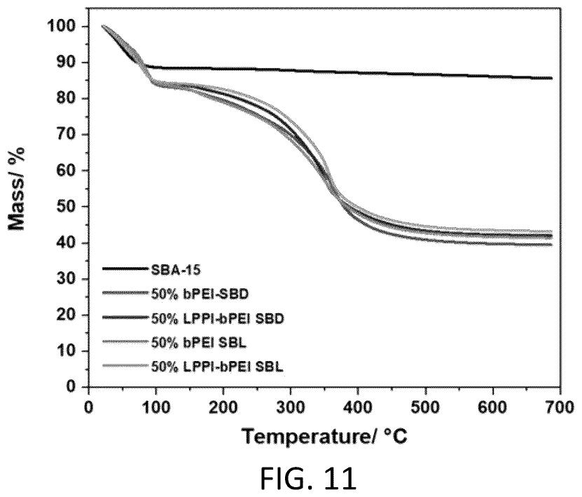

After synthesis, the SPISS samples were thermogravimetrically combusted under nitrogen to determine their organic content that was evaluated from the 150° C. and 700° C. temperature range (FIG. 11, Supplementary Material). In addition, elemental analysis (EA) was used as a secondary method to validate the chemical composition of the SPISS samples (Table 1 and Table 4, Supplementary Material). The EA values were further used in the CO₂ adsorption performance.

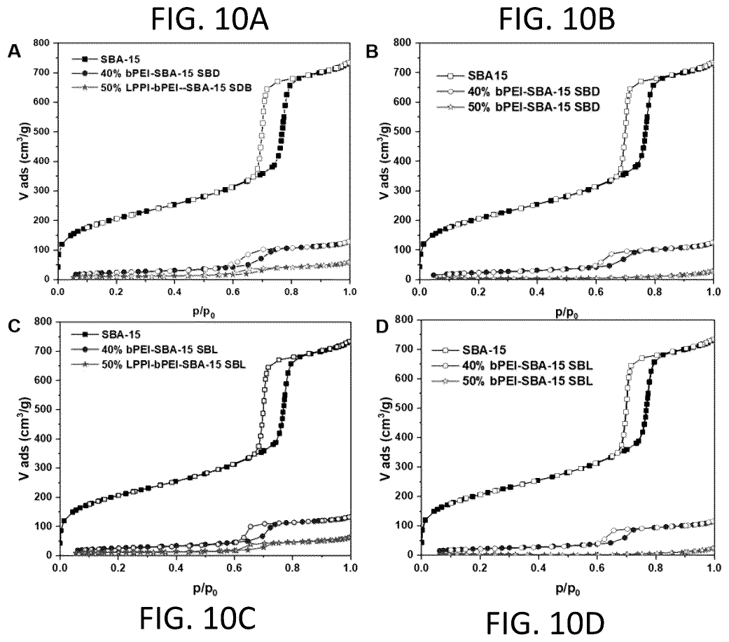

Cryogenic N₂ physisorption was used to evaluate the surface specific area and the pore parameters of the materials. As listed in Table 1 and displayed in FIGS. 10A to 10D (Supplementary Material) the pristine SBA-15 had a Brunauer-Emmett-Teller (BET) surface area of 797 (m²/g). Regardless of the batch processing method, SBL or SBD, this value decreased substantially for all samples. As expected, the reference 40% bPEI-SBA-15 samples displayed relatively close values, in the range of 81 m²/g to 96 m²/g (Table 4, Supplementary Material). The 50% organic-loaded samples presented interesting trends. The batches prepared from bPEI alone by both the SBL and SBD methods had similar BET values 6.4 m²/g and 11 m²/g, respectively. The other two containing blends of LPPI and bPEI had slightly higher BET values than the bPEI analogues but were also close, 40 m²/g (50% LPPI-bPEI-SBA-15 SBL) and 36 m²/g (50% LPPI-bPEI-SBA-15 SBD). Not surprisingly, the presence of the amine polymers in the silica mesopores drastically reduced the pore volume relative to the bare SBA-15 support (Table 1 and Table 4). The amine contents of the 50% bPEI-SBA-15 SBD and 50% bPEI-SBA-15 SBL were 20.5 mmol N/gₛᵢₒ₂ and 22.5 mmol N/gₛᵢₒ₂. In the blends, 50% LPPI-bPEI-SBA-15 SBL and 50% LPPI-bPEI-SBA-15 SBD, the N content values were 16 mmol N/gₛᵢₒ₂ and 18.2 mmol N/gₛᵢₒ₂, respectively. The smaller values of the latter were caused in part by the higher contribution of the carbon stemming from LPPI to the overall elemental composition of the samples. Irrespective of the processing method, the pore filling percentages associated with the above listed N contents were identically centered at 98% for the non-blends (bPEI) and at 93.5% for the blends (LPPI-bPEI). These trends suggest that the processing approach did not significantly influence the overall polymer occupancy of the SBA-15 pores. The values for all samples including the references (40% bPEI-SBA-15) are listed in Table 4 (Supplementary Material).

TABLE 1
Sample Name, Percentage of Organic Content from Elemental Analysis,
Nitrogen (N) Content, Surface Specific Area (BET), Pore Volume
and Percentage of Pore Filling for the SPISS samples

| | Organic | | Surface | Pore | Pore |
|---|---|---|---|---|---|
| | Content | N Content | Area, BET | Volume | Filling |
| Sample | (EA, %) | (mmol/g) | (m²/g) | (cm³/g) | (%) |
| SBA-15 | — | — | 797 | 1.08 | — |
| 50% LPPI-bPEI- | 47.5 | 18.2 | 36 | 0.07 | 93.5 |
| SBA-15 SBD | | | | | |
| 50% bPEI-SBA-15 | 46.5 | 20.5 | 11 | 0.02 | 98.0 |
| SBD | | | | | |
| 50% LPPI-bPEI- | 42.6 | 16.0 | 40 | 0.07 | 93.5 |
| SBA-15 SBL | | | | | |
| 50% bPEI-SBA- | 49.0 | 22.4 | 6.4 | 0.02 | 98.0 |
| 15 SBL | | | | | |

CO₂ performance of the SPISS samples under dry conditions.

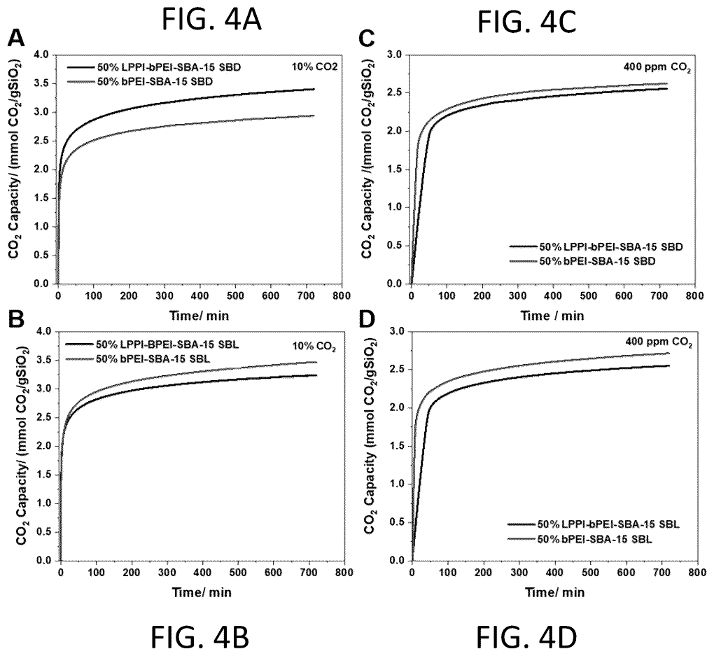

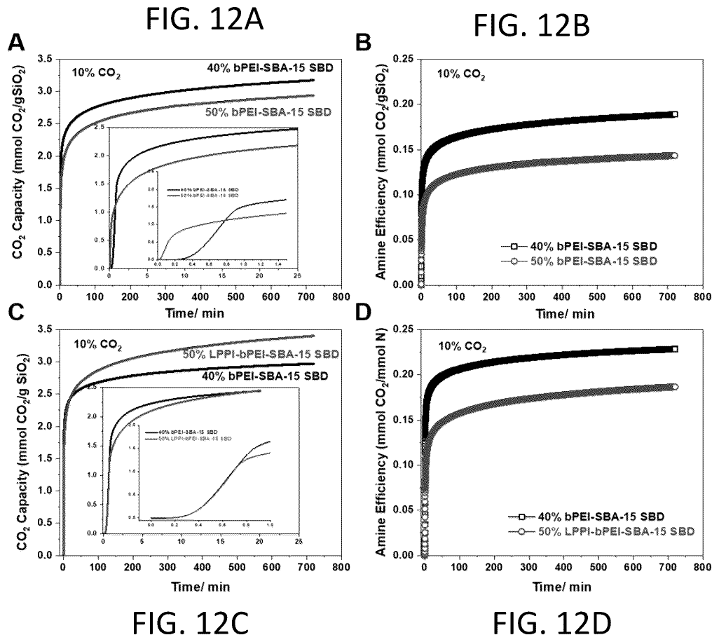

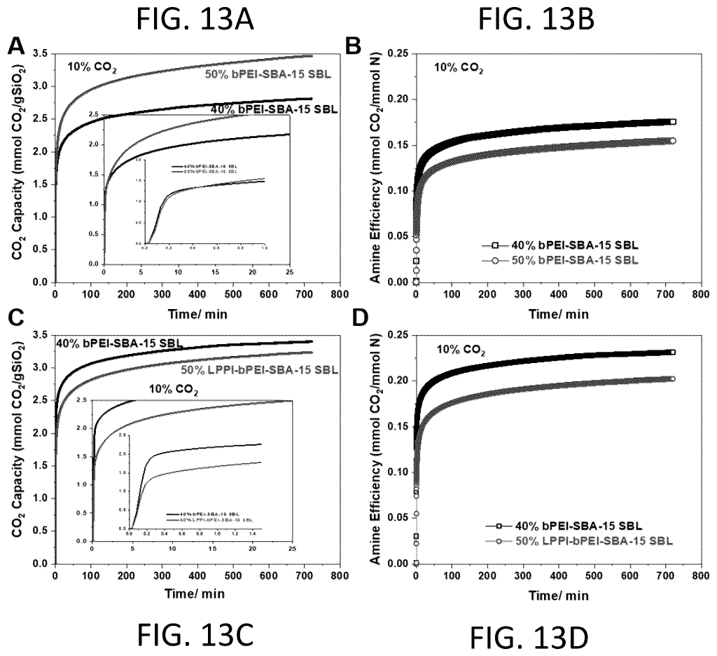

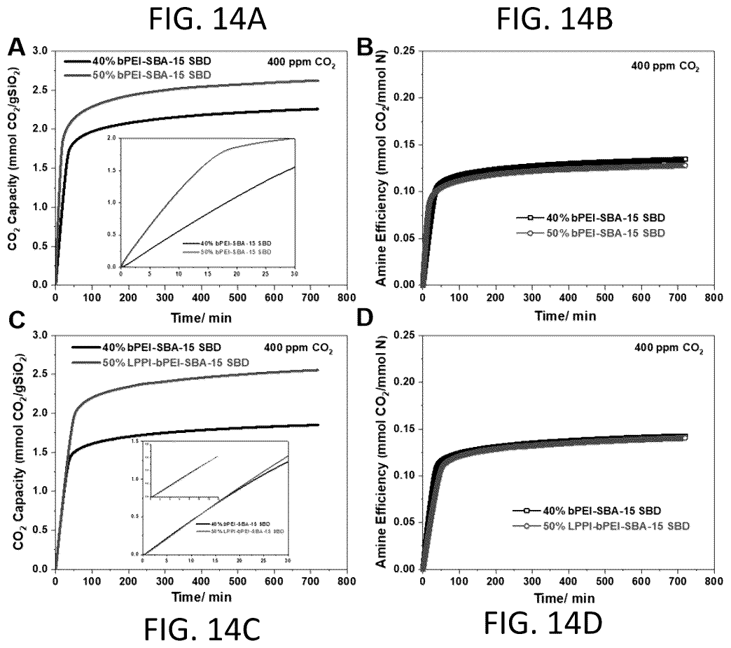

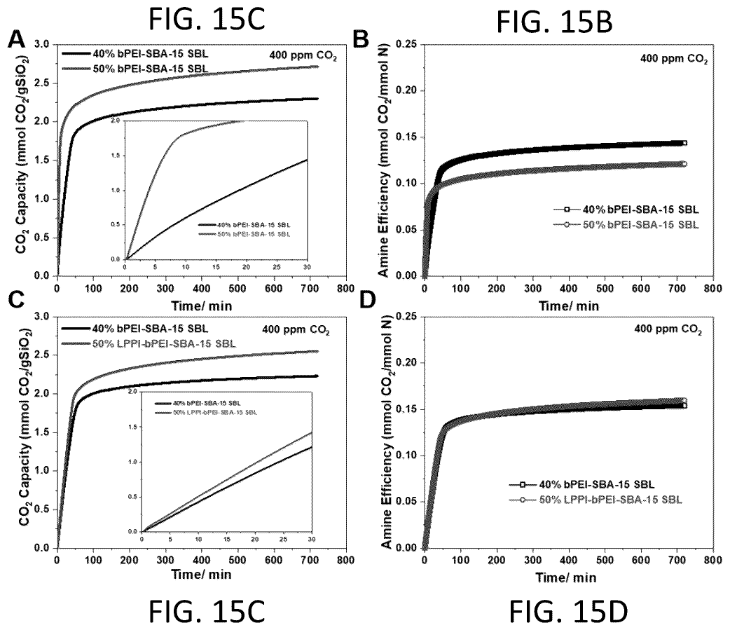

The main objective of this study was to investigate how to manipulate processing of the sorbent materials containing the commonly used amine polymer bPEI, especially for application in DAC technology, and potentially induce enhanced CO₂ adsorption performance. Hereon the discussion will focus exclusively on the 50% organic-loaded SPISS samples. As displayed in FIG. 4 and listed in Table 2, all samples showed high CO₂ uptake values. For example, under the 10% CO₂ conditions, the CO₂ capacity (CC) of the non-blends 50% bPEI-SBA-15 SBL and 50% bPEI-SBA-15 SBD were 3.47 mmol CO₂/gₛᵢₒ₂ and 2.94 mmol CO₂/gₛᵢₒ₂, corresponding to the amine efficiency (AE) values of 0.15 mmol CO₂/mmol N and 0.14 mmol CO₂/mmol N, respectively. For the DAC relevant conditions (400 ppm CO₂) the CC values were 2.72 mmol CO₂/gₛᵢₒ₂ and 2.62 mmol CO₂/gₛᵢₒ₂ with AE values of 0.12 mmol CO₂/mmol N and 0.13 mmol CO₂/mmol N. These values are among the highest reported for these conditions, as compared to literature reports. 41, 53, 61 The CC values of the blends 50% LPPI-bPEI-SBA-15 SBD and 50% LPPI-bPEI-SBA-15 SBL were 3.40 mmol CO₂/gₛᵢₒ₂ and 3.24 mmol CO₂/gₛᵢₒ₂ corresponding to AE values of 0.19 mmol CO₂/mmol N and 0.20 mmol CO₂/mmol N under 10% CO₂ conditions. Under the DAC conditions, the CC values were identical for the two blend samples, 2.55 mmol CO₂/gₛᵢₒ₂, while the associated AE values were 0.14 mmol CO₂/mmol N and 0.16 mmol CO₂/mmol N, respectively. The kinetic curves for the 40% reference samples are available in Supplementary Material, FIGS. 12-15 and Table 5. The difference noted in the CC values especially of the non-blend samples processed by SBL and SBD methods under both simulated flue gas (10% CO₂) and ultra-dilute air (400 ppm CO₂) conditions could indicate that the accessibility of the active amine sites inside the channels varied as a function of processing. One may hypothesize that the method of processing affected the morphology of the bPEI films deposited at the pore walls and the structure of the subsequent bPEI ‘plugs’ formed within the pore confinement.⁶²

TABLE 2
Sample Name and CO₂ Stream Concentration/Uptake
for the SPISS Samples after 12 hr adsorption in corresponding
CO₂ stream at 35° C.

| CO₂ Stream Concentration/Uptake | |
|---|---|
| 10% | 400 ppm |

| Sample | CC | AE | CC | AE |
|---|---|---|---|---|
| 50% LPPI-bPEI- | 3.40 | 0.19 | 2.55 | 0.14 |
| SBA-15 SBD | | | | |
| 50% bPEI-SBA- | 2.94 | 0.14 | 2.62 | 0.13 |
| 15 SBD | | | | |
| 50% LPPI-bPEI- | 3.24 | 0.20 | 2.55 | 0.16 |
| SBA-15 SBL | | | | |
| 50% bPEI-SBA- | 3.47 | 0.15 | 2.72 | 0.12 |
| 15 SBL | | | | |

*CC- CO₂ Capacity (mmol CO₂/g_{SiO2}) and AE-amine Efficiency (mmol CO₂/mmol N)

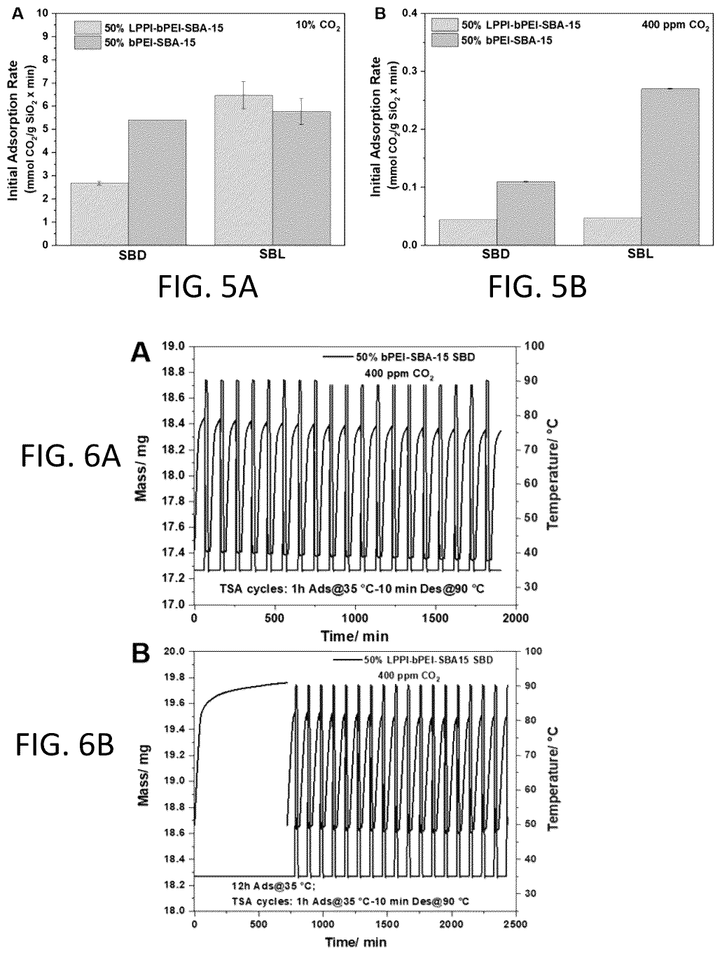

To better understand the differences between the CO₂ performance values, it was necessary to extract more information from the kinetic adsorption curves shown in FIG. 4. One of the most important parameters that informs the use of sorbents in a practical setup is the initial adsorption rate. This value computed from the ascending linear region of the kinetic curve reflects how fast most of the CO₂ adsorption occurs before approaching a pseudo-equilibrium state. As illustrated in FIGS. 5A and 5B, the initial adsorption rate values for the SPISS samples processed by the SBD method were different from those of the samples processed by the SBL approach indicating that processing could have an impact on adsorption kinetics. For comparison reasons, the insets in the kinetics profiles that show the linear fast regime and reflects the initial rates are plotted in FIGS. 12-15 (Supplementary Material).

Under 10% CO₂ conditions (FIG. 5A) the initial rate of the blend 50% LPPI-bPEI-SBA-15 SBL was approximately twice that of the 50% LPPI-bPEI-SBA-15 SBD while the rate for the non-blend samples, 50% bPEI-SBA-15 SBL & SBD, were essentially identical. The rate value for the blend 50% LPPI-bPEI-SBA-15 SBL was close in value with that of the non-blend 50% bPEI-SBA-15 SBL. Interestingly, the rate for the 50% LPPI-bPEI-SBA-15 SBD was half that of the non-blend 50% bPEI-SBA-15 SBD and 50% LPPI-bPEI-SBA-15 SBL homologues. The data could suggest that the presence of the LPPI did not negatively affect the diffusion and the amine site accessibility of the CO₂ molecules in the SBL samples while in the 50% LPPI-bPEI-SBA-15 SBD sample apparently the diffusion and access to the amine sites were significantly hindered. It is known that under dry 10% CO₂ conditions all amines, primary, secondary and tertiary can participate, with the latter participating by only physisorption.⁶³ Fast kinetics reflected by high adsorption initial rates imply that the morphology of the confined amine-containing sorbent enables rapid access to the amine sites and favorable diffusion path length for the CO₂ molecules. The fact that 50% LPPI-bPEI-SBA-15 SBD sample had significantly smaller rate than 50% LPPI-bPEI-SBA-15 SBL sample could indicate that the morphology of the two confined LPPI and bPEI macromolecules facilitates different amine-site-CO₂ molecule interactions, thus their morphology is likely different.

Under 400 ppm CO₂ stream conditions, the 50% bPEI-SBA-15 sample had the highest rate value among all samples (FIG. 5B). Furthermore, the rate of 50% bPEI-SBA-15 SBL was more than twice that of the 50% bPEI-SBA-15 SBD, while the rates of the LPPI-containing analogues were similar. This trend was quite the opposite of the one observed for the 10% CO₂ conditions. The data could indicate that the presence of LPPI in the blend samples did not favor fast kinetics as observed in the non-blend analogs. Unlike 10% CO₂ conditions, only the primary amines have the dominant contribution to CO₂ adsorption under 400 ppm CO₂ stream.⁶³ LPPI contributes with mainly secondary amines, which are less active toward CO₂ adsorption. In the blends, mixing of LPPI and bPEI likely led to primary amine site hindrance to some extent. Comparison between non-blend samples revealed that the morphology of bPEI in the SBL-processed sample was markedly more favorable to fast amine-site access and fast CO₂ diffusion than in SBD-processed homologue. Combination between the data observations from both 10% CO₂ and 400 ppm CO₂ conditions indicate that the processing methods could have impacted the morphology of the amine-containing polymer and their chain mobility during adsorption at 35° C.

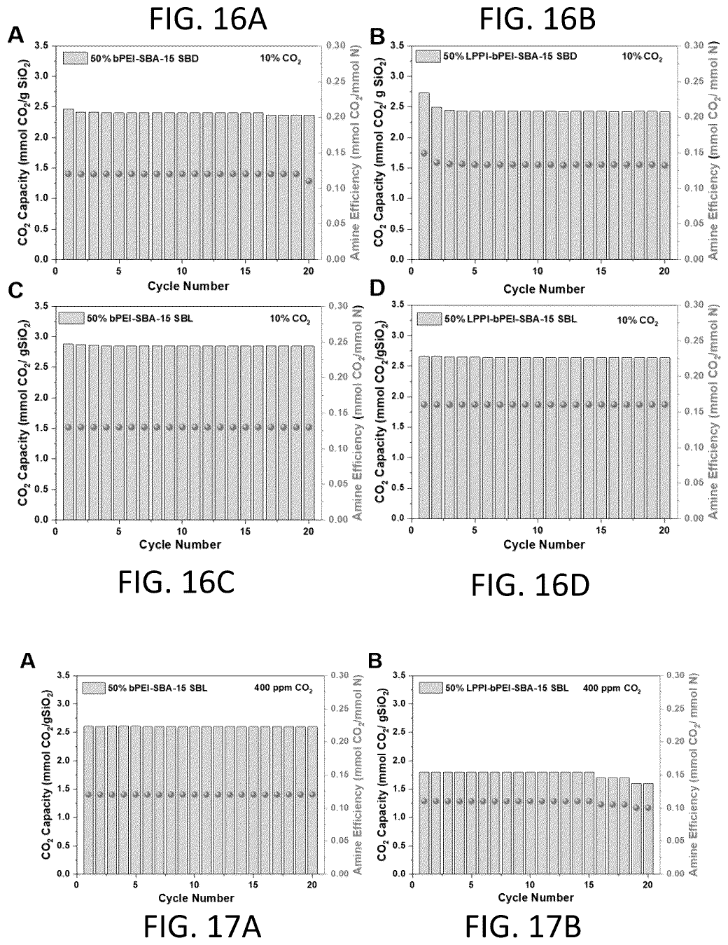

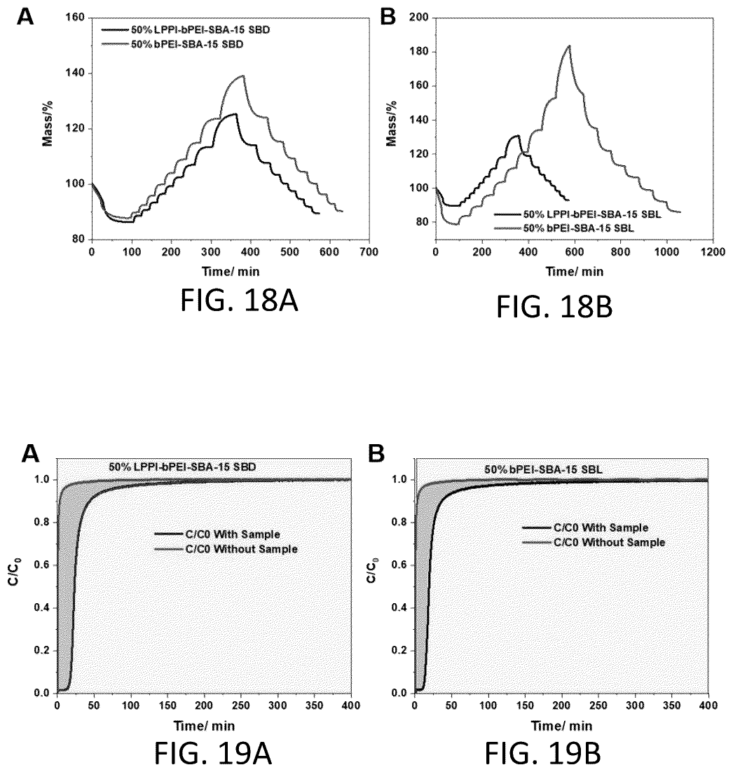

The SPISS samples were further subjected to temperature-swing adsorption-desorption kinetic cycles (TSA) to test their behavior under cycling conditions (Table 3). FIG. 6A shows the CO₂ uptake profile recorded during TSA cycles (20) of adsorption-desorption akin to actual operation conditions of rapid cycling. One sample, 50% LPPI-bPEI-SBA-15 SBD, was subjected to combined 12 h adsorption, approaching pseudo-equilibrium, followed immediately by TSA cycles (18) (FIG. 6B) under 400 ppm CO₂ conditions. All samples were initially pretreated at 110° C. for 2 h (not pictured) to remove moisture and adsorbed atmospheric CO₂. Following pretreatment, the 50% LPPI-bPEI-SBA-15 SBD sample (FIG. 6B) was exposed to 12 h isothermal CO₂ adsorption at 35° C., 1 h desorption at 90° C. and rapid isothermal cycling of 1 h adsorption and 10 min desorption. The rest of the samples (see FIGS. 16-17, Supplementary Material) were subjected only to TSA cycling (20) under both CO₂ stream conditions. As shown in FIG. 6B, the profile of the TSA cycles clearly shows that 100% of the fast region observed in the 12 h kinetic curve was reached quickly, within 1 h during extended cycling. The same trend was observed for all other samples by comparing the TSA cycles from FIG. 6A and FIGS. 16-17 (Supplementary Material) with the kinetic curves shown in FIG. 4. Furthermore, the SPISS sample showed steady adsorption-desorption behavior during cycling, which is critical in practical operation.

Table 3 summarizes the TSA performance values recorded for the SPISS samples during this cycling. The highest CC values were recorded for 50% bPEI-SBA-15 SBL, 2.85 mmol CO₂/gₛᵢₒ₂ (10% CO₂) and 2.60 mmol CO₂/gₛᵢₒ₂ (400 ppm CO₂), associated with AE values of 0.13 mmol CO₂/mmol N (10% CO₂) and 0.12 mmol CO₂/mmol N (400 ppm CO₂), respectively. Intriguing was the CC value obtained for the 50% bPEI-SBA-15 SBD sample, 2.45 mmol CO₂/gₛᵢₒ₂ under the 400 ppm CO₂ stream, similar to the 2.42 mmol CO₂/gₛᵢₒ₂ measured for the 10% CO₂ stream. In addition, the AE values were similar and centered at 0.12 mmol CO₂/mmol N.

Apparently, both blend and the non-blend SBL-processed samples had higher CC values than their SBD homologues under 10% CO₂ conditions while the 50% bPEI-SBA-15 SBL scored the highest value under 400 ppm CO₂ stream. All SPISS samples showed a robust steady behavior during TSA cycling that is of important practical relevance especially for DAC technologies. Such stable TSA behavior that does not cause thermal degradation or deactivation of amine sites is ideal for sorbent regeneration methods that involve elevated temperature. Altogether, the CO₂ performance data gathered under continuous and TSA dry conditions could suggest that the processing methods influenced the morphology of the confined amine polymer.

TABLE 3
Sample Name and CO₂ Stream Concentration and Uptake for the SPISS
Samples after TSA cycling with 1 hr adsorption at 35° C. and 10
min desorption at 90° C. with corresponding CO₂ stream

| | CO₂ Stream Concentration/Uptake | | | |
|---|---|---|---|---|
| | 10% CO₂ | | 400 ppm CO₂ | |
| Sample | CC | AE | CC | AE |
| 50% LPPI-bPEI-SBA-15 | 2.43 | 0.13 | 2.00 | 0.11 |
| SBD | | | | |
| 50% bPEI-SBA-15 SBD | 2.42 | 0.12 | 2.45 | 0.12 |
| 50% LPPI-bPEI-SBA-15 | 2.64 | 0.16 | 1.80 | 0.11 |
| SBL | | | | |
| 50% bPEI-SBA-15 SBL | 2.85 | 0.13 | 2.60 | 0.11 |

CO₂ adsorption performance of the SPISS samples under humid conditions.

In practical cycling under DAC conditions, the adsorption process needs to accommodate the presence of the moisture, as water is ubiquitously present in the air. It is known that water can compete with CO₂ molecules during adsorption, leading to either increased (some amine materials) or decreased (most physisorbents) performance, as reported in the literature.⁶⁴ The adsorption behavior of the water depends greatly on the sorbent type. From this perspective, it was important to test the CO₂ performance of the SPISS samples using simulated, humid, ultra-dilute CO₂ streams.

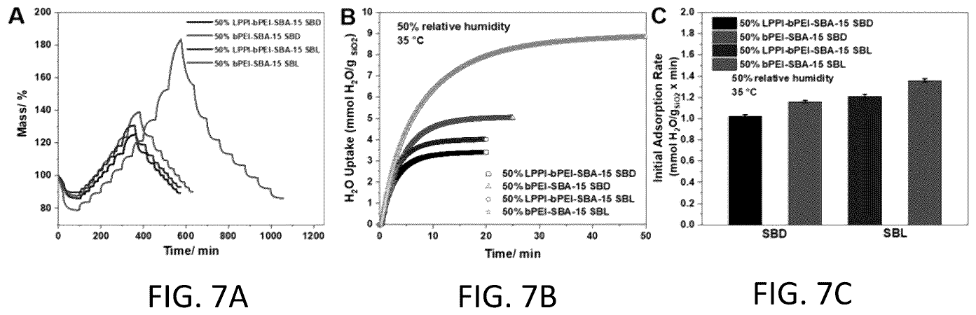

Prior to multicomponent adsorption experiments, water sorption by the SPISS samples was first evaluated with single component water adsorption experiments. In the dynamic vapor sorption (DVS) measurements the samples were subjected to pretreatment at 60° C. in a thermogravimetric analyzer (TGA from TA Instruments) until the relative humidity showed a null value. After a temperature ramp to 35° C., water was then added sequentially in isothermal sequences of 10% with equilibrations in between until a constant mass was achieved (<0.05%). As displayed in FIG. 7, DVS profiles of the SPISS samples showed higher water uptake for the 50% bPEI-SBA-15 samples (SBL & SBD) than the 50% LPPI-bPEI-SBA-15 materials (SBL & SBD). Regardless of the batch processing, SBL or SBD, the bPEI-LPPI blends showed a similar 35 wt % increase in water uptake. The highest mass increase was observed for the 50% bPEI-SBA-15 SBL, significantly higher than that of the 50% bPEI-SBA-15 SBD analogue. These data confirmed that LPPI can act as a moisture barrier, and unexpectedly, that there were significant differences between 50% bPEI-SBA-15 SBL and 50% bPEI-SBA-15 SBD, supporting the hypothesis that the processing method influenced the morphology of the polymer.

Additional information about the water sorption behavior was extracted from the DVS curves (FIG. 7A). The kinetic profiles displayed in FIG. 7B and recorded at 50% relative humidity (RH) and 35° C. unraveled more trends, especially between the LPPI-containing samples. Note that these chosen conditions are relevant for the simulated humid CO₂ adsorption conditions that will be later discussed. While the overall trend in water uptake did not change, it was apparent that at 50% RH the 50% LPPI-bPEI-SBA-15 SBL sample adsorbed slightly more water than the 50% LPPI-bPEI-SBA-15 SBD analogue, 4.00 mmol H₂O/gₛᵢₒ₂ vs. 3.40 mmol H₂O/gₛᵢₒ₂, respectively. Because calculations from the kinetic curves (FIG. 7B) account for the solid support (gₛᵢₒ₂), and the mass change (FIG. 7A) considers the overall sample (amine sorbent+solid support), the latter discussed trend could also be associated with the slight differences in the SPISS samples' organic loadings, thus N content. As a reminder to the reader and as listed in Table 1, in the 50% LPPI-bPEI-SBA-15 SBL the N content was 16 mmol N/gₛᵢₒ₂ while in the 50% LPPI-bPEI-SBA-15 SBD, it was 18.2 mmol N/gₛᵢₒ₂. Yet, the trend between these two samples appeared counterintuitive because, typically, a larger amount of N sites would equate with a larger mass of adsorbed water (FIG. 7B). The water uptake for the non-blend bPEI samples also showed unexpected trends. The water uptake for 50% bPEI-SBA-15 SBD (20.5 mmol N/gₛᵢₒ₂) was 5.02 mmol H₂O/gₛᵢₒ₂ and that of the 50% bPEI-SBA-15 SBL (22.4 mmol N/gₛᵢₒ₂) was 8.85 mmol H₂O/gₛᵢₒ₂. The latter material required double the time to reach equilibrium. Therefore, the marked difference in water uptake between the non-blend samples cannot be assigned solely to the slightly larger N content. Yet, the water uptake of the non-blend samples was in contrast with that of the blend analogues with respect to the N content. These findings clearly support the hypothesis that LPPI limits the water uptake in these materials. The results also provide additional support to the hypothesis that processing could influence the morphology of the amine-containing polymers under confinement.

Another useful piece of information extracted from the kinetic curves was the initial rate of water adsorption (FIG. 7C). Interestingly, there was no significant difference in the rate values between the samples. The initial rate value trend was ascending, with the SBL-processed samples showing slightly faster rates than SBD-processed ones. From a comparison with the initial rates of CC calculated under dry conditions and 400 ppm CO₂ (FIG. 5B), it is apparent that at 50% RH, water adsorbs faster than CO₂.

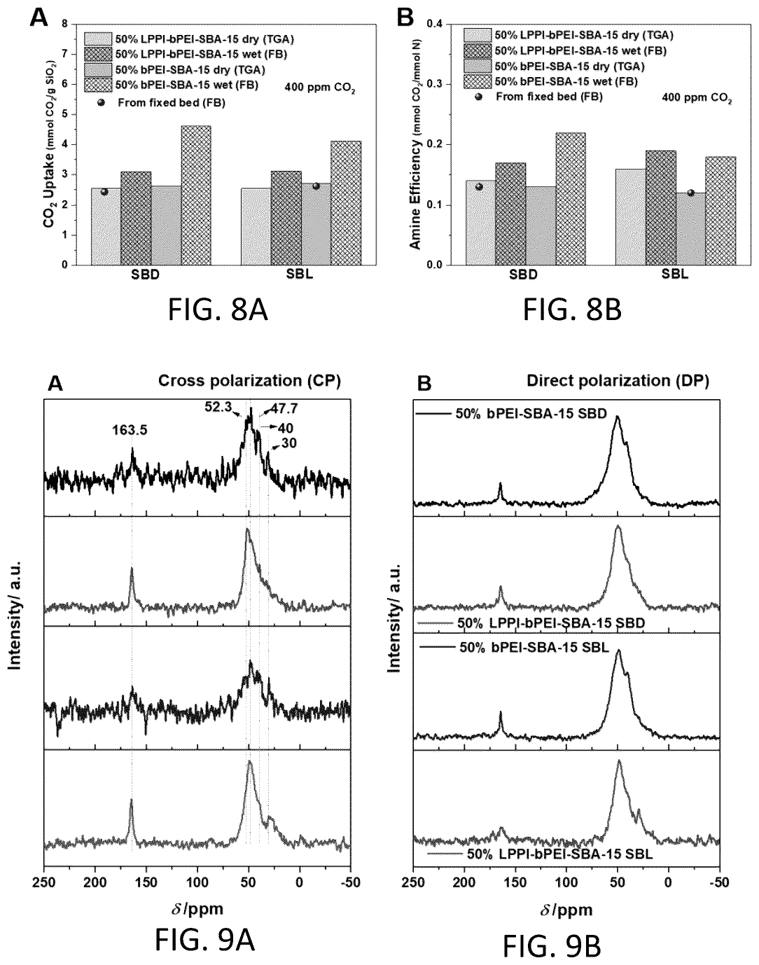

Once the water sorption behavior was investigated, the next step was to gather information about the CO₂ performance of the SPISS samples under humid 400 ppm CO₂ because, as mentioned above, these conditions have practical relevance to the DAC technology. For the purpose of accurate comparison between dry and humid conditions it was important first to test whether there were significant differences between dry CO₂ adsorption determined gravimetrically (TGA) and using the fixed bed contactor (FB). As shown in FIG. 8A for the selected samples, the dry FB (blue dots) and the dry TGA (yellow (SBD) and purple (SBL) columns) values were within experimental error. The CO₂ capacity and amine efficiency numbers calculated from FB breakthrough curves were 2.40 mmol CO₂/gₛᵢₒ₂ and 0.13 mmol CO₂/mmol N for 50% LPPI-bPEI-SBA-15 SBD and 2.62 mmol CO₂/gₛᵢₒ₂ and 0.12 mmol CO₂/mmol N for 50% bPEI-SBA-15 SBL. These results also indicate that the state of the sample used in the two different measurements (e.g. fine powder (TGA), 300-600 μm granulated pellets (FB)) did not have a marked effect on the CO₂ adsorption.

Under humid conditions (50% RH & 35° C.), all SPISS samples showed enhanced CC when compared with the dry conditions (FIG. 8). The breakthrough profiles are available in Supplementary Material, FIG. 19. The highest CC was displayed by non-blend samples: 4.62 mmol CO₂/gₛᵢₒ₂ (50% bPEI-SBA-15 SBD) and 4.13 mmol CO₂/gₛᵢₒ₂, respectively (FIG. 8A). These values represent an increase of 76% and 52% with respect to the ones recorded under dry conditions (Table 2). The samples containing LPPI had similar CO₂ uptakes centered at 3.10 mmol CO₂/gₛᵢₒ₂, accounting for 22% increase when compared to the similar dry values of 2.55 mmol CO₂/gₛᵢₒ₂. The increase in CO₂ uptake was also reflected in the amine efficiencies shown in FIG. 8B. The 50% bPEI-SBA-15 SBD sample had the highest value, 0.22 mmol CO₂/mmol N, an increase of 69% from the dry value (0.13 mmol CO₂/mmol N, Table 2). The AE of the SBL-processed samples increased by only 12.5% to 0.18 mmol CO₂/mmol N (FIG. 8B). Despite similar CC numbers, the trend in AE for the blended samples was different: the AE of 50% LPPI-bPEI-SBA-15 SBD increased with 21.5% to 0.17 mmol CO₂/mmol N while the AE for 50% LPPI-bPEI-SBA-15 SBL increased with 58.3% to 0.19 mmol CO₂/mmol N. These results indicate that the presence of water essentially had no negative effect on CC and AE for any sample. Intriguingly, the bPEI-based samples that showed high water uptake also had the highest CC. Yet, water seemed to limit to some extent the CO₂ uptake in the 50% bPEI-SBA-15 SBL sample when compared to SBD-processed analogue. Recall that this sample had a significantly higher water sorption capacity from single component experiments compared to all other samples (FIG. 7). The different AE values observed for bPEI-LPPI blends suggests that the access to the amino groups in the samples could be different. These findings alongside the ones discussed above could support the assumption that processing impacts the morphology of the two amine polymers under confinement in the silica pores.

Insights into the dynamics of bPEI/LPPI polymer chains confined in SBA-15 channels. The data discussed in the preceding paragraphs could indicate that the processing of the SPISS samples, SBD vs. SBL and blends vs. use of PEI alone, influences their CO₂ adsorption properties. These differences likely stem from different morphologies of the amine-containing polymers confined in the SBA-15 pores. Solid state NMR spectroscopy techniques were employed to investigate the correlation between molecular motion, morphology and mechanical relaxation processes. High-resolution ¹³C cross-correlation (CP) and high-resolution ¹³C direct-polarization (DP) Magic Angle Spinning (MAS) techniques were used to investigate whether the region of the recorded spectra associated with the aliphatic groups reflects structural differences as a function of sample composition and processing (FIG. 9). All spectra were characterized by at least one peak around 164 ppm associated with bound CO₂ from ambient air during sample handling. A pattern that includes several overlapping peaks was observed in the range between 30 and 60 ppm. Considering only the isotropic chemical shifts—as observed in solution NMR-peaks corresponding to the following chemical sites are expected: for LPPI a peak at ˜46 ppm assigned to the α-CH₂-directly adjacent to secondary amine-groups and a peak at ˜25-30 ppm corresponding to β-CH₂ that is sandwiched between two of the α-CH₂ sites. For bPEI, the expected resonances are: 50-57 ppm for CH₂-sites adjacent to a tertiary amino group, 47-53 ppm for CH₂-sites adjacent to a secondary amino group and 38-42 ppm for CH₂-sites adjacent to a primary amino group. All these sites can be identified as either peaks or shoulders within the spectra of FIG. 9A (52.3 ppm, 47.7 ppm, 40.0 ppm and ˜25-30 ppm).

However, it should also be noted that chemical shifts in the solid state also depend on the conformation of the polymer chains. Especially conformations defined by different torsional angles of a carbon-carbon bond are known to lead to changes in the chemical shift in polymers (the gamma-gauche effect). The result is a significant broadening of line widths due to a distribution of possible torsional angles. Molecular motions around these torsional angles with frequencies larger than several kHz will lead to a motional averaging of line widths, i.e. narrower line widths corresponding to individual chemical sites and averaged torsional angles. The spectra displayed in FIG. 9 showed some interesting differences between the individual samples. Firstly, the CP spectra of the samples containing only bPEI displayed extremely low signal intensity (FIG. 9A). This is apparent by the low signal to noise in FIG. 9A, (black and blue traces). Note that the spectra for non-blends (bPEI) and blends (bPEI-LPPI) were recorded using the same large number of scans and in both cases the stability of the cross-polarization conditions was checked and confirmed using a reference sample immediately before and after the experiment. This reduced signal intensity in comparison to the compounds containing bPEI and LPPI cannot be due to a reduced amount of sample, as confirmed by the gravimetric/elemental analysis data from Table 1 and FIG. 11 (Supplementary Material). In addition, the fact that it is possible for both sets of samples to record DP spectra with a good signal to noise ratio further dismissed this possibility. The poor signal intensities for the CP spectra should, therefore, be due to a dynamic effect. Motions occurring in the range of frequency field of the cross polarization (50 kHz) may lead to a minimum of the time constant Tip and therefore a fast decay of the magnetization during the cross-polarization process.

On the other hand, motions faster than ˜ 25 kHz can also lead to a significant reduction of the heteronuclear dipolar coupling constant between ¹³C and 1H and thus a slow buildup of the cross polarization, which will also reduce the intensity of the signal in the CP spectrum. However, motions with this frequency range should also lead to some motional narrowing detectable through the narrowing of an individual peak, which should be apparent in the DP spectra. Given the multitude of chemical sites and conformers, which all correspond to one individual peak, their overlap may still lead to a pattern apparently including only a few peaks. For the samples containing both polymers it was possible to record CP-spectra with a reasonable signal to noise ratio. Hence, in both cases, the presence of the LPPI leads to molecular dynamics at presumably lower frequencies associated with more favorable conditions for the CP experiment.

The second striking difference between the individual ¹³C-MAS spectra is the presence of a peak/shoulder at ˜30 ppm, which is prominently observed in the DP (FIG. 9B) and somewhat less in the CP (FIG. 9A) spectrum of 50% LPPI-bPEI-SBA-15 SBL. Looking at the above peak assignments, this resonance must be due to the β-CH₂ moieties in the LPPI polymer. The fact that this peak is more pronounced and narrower in the DP spectrum points to a distribution of motions with different correlation times. The faster motions among this distribution lead to a motional averaging, which is detected prominently as a narrow peak in the DP spectrum, while it is suppressed in the CP spectrum due to unfavorable conditions for the cross polarization. It is interesting to note that this peak at around 25-30 ppm is barely apparent as a shoulder in the CP and DP spectra of 50% LPPI-bPEI-SBA-15 SBD. This fact points towards a smaller amount of molecular mobility for the LPPI within the SBD-processed sample. The peak attributed to “motionally-narrowed” β-CH₂ is not present in the DP spectrum. Furthermore, the almost complete disappearance of the peak at 25-30 ppm can only be explained by an additional downfield chemical shift of a few ppm leading to an overlap with peaks corresponding to other moieties. The shift can also be explained by the gamma-gauche effect, where a predominantly trans configuration would lead to this change in chemical shift (i.e. a higher conformational order is likely to be present for the LPPI chains within the SBD sample).

Hence, we hypothesize that the presence of LPPI in the blend samples also improves the ordering of bPEI. During mixing of the two polymers, LPPI can better bridge the bPEI, ‘smoothing’ the interfaces between the two polymers. However, it is obvious that the observed variation in spectral features as a function of processing suggests that packing of polymer chains is different for the samples under investigation.

The findings of this study indicate that the processing during sample synthesis was the key factor that influenced the morphology of the two amine polymers confined in the pores and induced enhanced adsorption properties in some cases. The NMR experiments further support this hypothesis and begin to unravel important insights about the mobility of the bPEI and LPPI polymers residing under pore confinement. It is reasonable to assume, based on classical polymer dynamics theories, 65, 66 that likely bPEI and LPPI, due to their different conformations (branched versus linear), did not mix well in the channel; rather, they were segregated to some degree. At the same time, bPEI and LPPI behave as molecular crowding entities₆₇ for each other, and within each (polydispersity effects), leading to multiple interfacial interactions (heterogeneity effects). These interactions, most likely entropic in nature, forced the segregated polymers to adjust their conformation by better aligning and ordering, especially when the solvent was evaporated.₆₈ These observations are in line with the views published in a comprehensive perspective by Chandran et al. stating that rapid processing induce nonequilibrium molecular conformations of polymers and subsequently lead to structural, dynamical and mechanical properties different from those in thermodynamic equilibrium.⁶⁹

Two consecutive solvent evaporation steps during the SBD method likely led to a tightly packed bulk conformal bPEI layer at the channel inner wall sequentially coated by thin layers of intermixed/segregated bPEI for non-blends and bPEI/LPPI for blends (FIG. 3, cartoon double polymer layers). In the case of the blend, it is reasonable to assume that due to small amount of bPEI from the conformal layer redispersed in the 10% LPPI/methanol solution, the second solvent evaporation favored a better LPPI-assisted bPEI ordering in tightly packed domains during the second SBD processing step. Again, the higher order (trans conformation) of LPPI in the SBD-processed sample observed by ¹³C CP and DP NMR indicate that the polymer chains are tightly packed. On the contrary, the presence of the resonance associated with LPPI in the SBL-processed sample (˜25-30 ppm) points to a loosely packed or more segregated morphology of the polymer chains. Solvent removal likely led to inner thicker layers containing domains of segregated bPEI/LPPI bridged together in a loose fashion (FIG. 3, interpenetrating polymer layers). The differences in the CO₂ adsorption properties could support the idea of tight vs. loose conformations.

From the standpoint of understanding the structure-processing-property relationship of these sorbents, it is important to connect the observed properties to the unraveled different morphology of bPEI/LPPI generated by the two processing approaches. If one takes in consideration the most important metric, amine efficiency (AE), both blends 50% LPPI-bPEI-SBA-15 SBD and 50% LPPI-bPEI-SBA-15 SBL were more efficient under 10% CO₂ while only the latter was more efficient under 400 ppm CO₂ conditions. The high initial rates observed for the SBL-processed samples, especially under dry 10% CO₂, correlate with a loose packing that likely favors fast kinetics (fast diffusion and amine-site access, FIGS. 5A and 5B) when compared with lower rates of SBD samples associated with tighter packing. In addition to the blends, 50% bPEI-SBA-15 SBL was also found effective when considering CC values for 10% CO₂ and the most effective under 400 ppm CO₂.

If the above assumptions for the dry one-component conditions are true, then opposite trends would be expected for the multicomponent humid experiments. In the DVS experiments, it was not surprising that the 50% bPEI-SBA-15 SBL sample adsorbed the most water (8.85 mmol H₂O/gₛᵢₒ₂), substantially higher than the 50% bPEI-SBA-15 SBD analogue (5.02 mmol H₂O/gₛᵢₒ₂). Because the samples had similar pore filling (Table 1), it is obvious that the different volume occupied by water was associated with tight vs. loose morphology of the polymer chains in the channel. A less compact morphology like in 50% bPEI-SBA-15 SBL, allowed better exposure of the amine sites for interaction with the adsorbate molecules. Second, once adsorbed in sufficient amounts, water can occupy the amine sites, making them less accessible to CO₂ during humid multicomponent adsorption experiments.⁶⁴ Regardless of the used metric AE or CC, 50% bPEI-SBA-15 SBD sample was markedly more effective under 400 ppm CO₂ humid stream, this could be due to its dense packed morphology allowed for less water sorption that did not as greatly compete with CO₂ adsorption than the 50% bPEI-SBA-15 SBL homologue (FIG. 8).⁷⁰ These results indicate that tuning of the processing-induced nonequilibrium conformations can lead to novel structural and dynamical properties⁶⁹ of polymeric sorbents under designed adsorption conditions for targeted CC and AE values.

### CONCLUSIONS

Samples including of branched polyethylenimine (bPEI, M_{w}=800 Da) and blends with linear polypropylenimine (LPPI, M_{w}=6,700 Da) were prepared by a method referred to as sequential polymer infusion into solid (SBA-15) substrates (SPISS). The purpose of this approach was twofold: (I) to enhance the CO₂ adsorption properties by varying the solution processing and (II) to probe whether the presence of hydrophobic LPPI can limit water uptake. A 40 wt % bPEI reference sample was prepared for each synthesis that was split in a 50:50 ratio. Splitting was performed in two ways: via a dry suspension (SBD) and a liquid suspension (SBL). Sequentially, alcoholic 10% bPEI for non-blends and alcoholic 10% LPPI for blends were added and the solvent was evaporated.

The 50% bPEI-SBA-15 SBL & SBD and 50% LPPI-bPEI-5 SBL & SBD samples displayed high CO₂ uptake when compared to literature reports under both simulated flue gas (10% CO₂) and DAC (400 ppm CO₂) conditions. The initial rate of adsorption revealed that in the SBL-processed samples the amine sites were faster accessed by the CO₂ molecules than in SBD-processed analogues, likely due to different polymer morphologies in the samples. Subjected to extended temperature-swing adsorption-desorption kinetic cycling (TSA, 20 cycles), the SBL-processed samples displayed higher CC than their SBD analogs for both 10% CO₂ and DAC conditions. The SPISS samples had stable working capacities with no apparent deactivation over the extended TSA cycles.

Dynamic vapor sorption measurements showed that LPPI limited the water uptake of the sorbents that contained blends of aminopolymer. The amount of water adsorbed by the 50% bPEI-SBA-15 SBL & SBD samples that was extracted from the CO₂ sorption kinetic curves at 50% RH again supported the hypothesis that different processing conditions impacted the morphology of the polymers in the pores. All samples showed enhanced CO₂ adsorption under the conditions relevant to DAC technology. Comparison between the CO₂ uptake of the pre-humidified 50% bPEI-SBA-15 SBL & SBD samples provided additional support to the idea that the morphology of the polymers in the SBA-15 channels is essentially different.

Solid state ¹³C NMR cross-polarization magic angle spinning (CP) and direct polarization magic angle spinning (DP) studies confirmed that the conformations of the bPEI in non-blends and the conformation of bPEI and LPPI in blends are different. The results indicated that polymer chains crowded each other and underwent ordering to differing degrees. In the SBD samples, polymer packing was tight while in the SBL samples packing was loose, with the later condition potentially aiding CO₂ sorption.

Altogether the data demonstrate that altering solution processing can identify conditions where polymer non-blends and blends give sorbents with improved overall CO₂ performance. The main findings showed that ordering of the active amine molecules can be a key factor in enhancing CO₂ adsorption properties. Equally important is the nature of the additive species (e.g. LPPI) that altogether with the process-induced morphology can fine tune the desired adsorption properties. This study is relevant for the preparation of amine sorbents with enhanced CO₂ performance and their integration into CO₂ capture technologies.

### Experimental Section

### Materials

Branched polyethylenimine (bPEI, M_{w}=800), tetraethyl orthosilicate (TEOS, reagent grade, 98%), pluronic P-123 (EO:PO:EO, Mₙ=5800 Da), hydrochloric acid (HCl, ACS reagent, 37%), and methanol (MeOH, for HPLC, ≥99.9%) were purchased from Sigma-Aldrich and used as received. UHP He, 400 ppm CO₂/He and 10% CO₂/He gases were procured from Airgas. Linear polypropylenimine (LPPI, Mₙ=6700 Da) was available in the laboratory and also used in a previous report. 42, 71

### Methods

### Thermogravimetric Analysis.

The organic content of the samples was evaluated by using a TGA 550 Discovery Series from TA Instruments. Data were recorded at a scan rate of 20° C./min under N₂ (90 mL/min) from room temperature to 700° C. The organic content was calculated from the 150° C.-600° C. temperature range.

### Elemental Analysis.

The elemental content of C, H, and N was determined by Atlantic Microlabs (Norcross, GA). The N content expressed in mmoles was calculated from the repeat unit formulae of both bPEI and LPPI and from the percentage contribution of each element from elemental analysis as well as the atomic mass of N. The calculated values were normalized per gram of silica support.

### N₂ Physisorption.

A Micromeritics Tristar II instrument was used for recording isotherms at 77 K. Prior to the analysis, the samples were subjected to pretreatment in a high-vacuum line operating at ˜10 mtorr for 12 h at 100° C. The surface area was determined by applying the BET theory in the 0.05-0.2 P/Po pressure range. The total pore volume was calculated based on the amount of N₂ adsorbed at P/Po of 0.95 using the formula

$$Pore volume = {Q}_{ads} \frac{1.2504}{807}$$

Where 1.2504 is the density of N₂ (g/cm³) at standard temperature and pressure conditions and 807 is the density of N₂ (g/cm³) at its boiling point.

### Dry CO₂ Adsorption Capacities.

A Q500 TGA apparatus (TA Instruments) was used to measure CO₂ adsorption capacities of the SPISS samples. The samples were first subjected to pretreatment by heating to 110° C. under He (90 mL/min) at a 10° C./min rate and held isothermally for 2 h to remove adsorbed ambient CO₂ and moisture. The samples were then cooled to 35° C. at the same rate and equilibrated for 1 h under helium. Then the inlet gas was switched to either 10% CO₂/He or 400 ppm CO₂/He (90 mL/min) and the samples were kept isothermal for 12 h. The recorded final mass used in the CO₂ adsorption capacity was normalized by the initial mass after 2 h pretreatment at 110° C. Two samples were tested in a custom-built fixed bed as will be discussed in a below paragraph. The purpose was to test reproducibility data between the two methods of recording CO₂ capacity. Statistical analysis of the calculated initial rates values variance was performed by ANOVA platform from Origin 2016. The general equation used by Anova is:

$${σ}^{2} = \frac{1}{n - 1} {Σ ( {y}_{i} - \overline{y} )}^{2}$$

where the denominator represents the degree of freedom, the summation is the sum of squares, the squared terms are the deviations from the variable mean and the result is the mean square.

### Temperature-Swing Adsorption-Desorption (TSA) Cycles.

These experiments were performed in the same instrument as described above and following the same program segment for pretreatment: isothermal for 2 h at 110° C. and 1 h at 35° C. under He. Afterward, repeat cycles (20) of isothermal adsorption (35° C. for 1 h under CO₂/He (10% or 400 ppm)) and isothermal desorption (90° C. for 10 min under He) were performed, allowing 10 min equilibration time at the adsorption temperature before gas switching.

### Humid CO₂ Adsorption Capacities.

A custom-built fixed bed set up was used to measure the CO₂ performance of the 50% organic loading SPISS samples. About 50 mg the sample was grinded to fine powder. A pelletizer was used to pelletize the powders by applying a pressure of 1000 psi for 30 seconds. The resulting pellets were crushed and sieved through a 300-600 μm sieve to afford particles of precise size. About 25 mg of sieved sample was encased in a ¼ inch diameter glass tube and supported by a bed of glass wool. The packed bed was activated in nitrogen (90 mL/min) at a temperature of 90° C. until there was no trace of CO₂ and H₂O downstream as indicated by a calibrated Li 840A CO₂/H₂O gas analyzer (LiCOR). The temperature of the bed was reduced to 35° C. The bed was then pre-saturated with a 50% RH nitrogen carrier gas until the H₂O concentration downstream was stable. Afterward, the bed was exposed to humid 400 ppm CO₂ balanced by nitrogen (50% RH) at a flow rate of 50 mL/min, and the increasing CO₂ concentration was monitored as a function of time until equilibrium was reached. Once the CO₂ concentration was stable, the temperature was ramped up to 90° C. in dry nitrogen for desorption. The procedure detailed here was repeated with an empty glass tube. An integral area between the two normalized breakthrough curves (glass tube—no sample; glass tube—with sample) was used to calculate the humid CO₂ adsorption capacity and amine efficiency.

### Dynamic Vapor Sorption (DVS).

A TGA Q5000 instrument (TA Instruments) equipped with a humidity module was used for the dynamic vapor sorption experiments. The SPISS samples were pretreated first at 60° C. for at least 1 h under dry nitrogen (200 mL/min) and until the sample RH sensor indicated null humidity. The temperature was decreased to 35° C. and equilibrated for 10 min. Then the humidity was set at 10% and the sample was kept isothermal for at least 1 h and until the humidity sensor indicated a percentage weight change <0.0500 for 5.00 min. For the adsorption part of the curve, this segment was repeated by sequentially adding 10% humidity until the maximum 100% RH. The desorption curve was obtained by the repeat program step with the difference that the humidity was decreased sequentially by 10% until reached the minimum of 0% RH.

### Solid State Nuclear Magnetic Resonance.

¹³C solid state NMR spectra were recorded under condition of magic angle spinning (MAS) on a Bruker AV3-300 HD operating at a ¹H frequency of 300 MHz. Samples were packed in 4 mm O.D. rotors and spun with a frequency of 10 kHz. ¹³C CP spectra were recorded using standard conditions; a ramp-shaped contact pulse for ¹H during a contact time of 3 ms and a repetition delay of 4 seconds and high power decoupling. ¹³C DP spectra were recorded under identical conditions of decoupling with a repetition delay of 5s.

### Syntheses

SBA-15. Mesoporous SBA-15 was synthesized by following a previously reported procedure.⁴²

SPISS SBD samples.

The SPISS samples were prepared by sequential bPEI (M_{w}=800 Da)/LPPI (Mₙ=6700 Da) infusion into the SBA-15 solid substrate by using two solution-processing approaches: split batch dry suspension (SBD) and split batch liquid suspension (SBL). The synthesis started with the preparation of the reference 40% bPEI-SBA-15 sample, a common step for SBD and SBL. In a typical reference synthesis, 500 mg of SBA-15 were suspended in 20 mL methanol (MeOH) in a 100 mL round-bottomed flask and sonicated for 30 min until a homogeneous suspension formed. Separately, bPEI (40 wt % with respect to the total mass (PEI+SBA−15)) was dissolved in 10 mL MeOH inside a 20 mL scintillation vial that was capped and the solution was magnetically stirred for 30 min. Afterward the PEI/MeOH solution was added to the flask containing SBA-15/MeOH and the suspension was magnetically stirred overnight. Then the reference sample was processed differently for the two approaches mentioned above. Four reference samples were necessary for this study, two for SBD and two for SBL. For SBD, the solvent from the reference sample was evaporated by using a rotary evaporator equipped with a water bath operating at 50° C. The resulting powder was then split in half (50:50). One half was kept as standard and the other half was suspended in a premade alcoholic (MeOH) solution of either 10% bPEI or 10% LPPI each dissolved in 10 mL solvent. The suspension was stirred overnight and the solvent was evaporated affording a fine white powder product. For SBL, the reference samples were split each in liquid suspension state (50:50) after vigorous shaking. Like SBD, one half was kept as standard and dried by rotary evaporation, and the other half was mixed with the 10% bPEI/MeOH and 10% LPPI/MeOH and stirred overnight. A fine white powder was obtained after solvent evaporation. All samples were subsequently dried in a high vacuum (˜10 mtorr) at 60° C.

### REFERENCES FOR EXAMPLE 1

1. Center for Climate and Energy Solutions, Main Greenhouse Gases, https://www.c2es.org/content/main-greenhouse gases/,(accessed July 2021).
2. Center for Climate and Energy Solutions, Global Emissions, https://www.c2es.org/content/international-emissions/, (accessed July 2021).
3. E. S. R. L. Global Monitoring Laboratory, Trends in Atmospheric Carbon Dioxide, https://qml.noaa.gov/ccgg/trends/gl_trend.html, (accessed July 2021).
4. C. C. United Nations, The Paris Agreement, https://unfccc.int/process-and-meetings/the-paris-agreement/the-paris-agreement, (accessed July 2021).
5. P. Gabrielli, M. Gazzani and M. Mazzotti, Ind. Eng. Chem. Res., 2020, 59, 7033-7045.
6. S. Teir, E. Tsupari, T. Koljonen, T. Pikkarainen, L. Kujanpaa, A. Arasto, A. Tourunen, J. Karki, M. Nieminen, S. Aatos, S. Teir, E. Tsupari, T. Koljonen, T. Pikkarainen, L. Kujanpaa, A. Arasto, A. Tourunen, J. Karki, M. Nieminen and S. Aatos, HIILIDIOKSIDIN TALTEENOTTO JA VARASTOINTI, 2009, 2503, 14-22.
7. S. Chu, Science, 2009, 325, 1599.
8. B. Smit, A.-H. A. Park and G. Gadikota, Frontiers in Energy Research, 2014, 2.
9. A. Al-Mamoori, A. Krishnamurthy, A. A. Rownaghi and F. Rezaei, Energy Technology, 2017, 5, 834-849.
10. P. Markewitz, W. Kuckshinrichs, W. Leitner, J. Linssen, P. Zapp, R. Bongartz, A. Schreiber and T. E. Müller, Energy Environ. Sci., 2012, 5, 7281-7305.
11. H. Li, Ø. Wilhelmsen and J. Yan, in Handbook of Clean Energy Systems, DOI:https://doi.org/10.1002/9781118991978 hces038. pp. 1-17.
12. National Energy Technology Laboratory, unpublished work.
13. Y. Hu and Y. Shi, Atmosphere, 2021, 12, 811.
14. U. S. I. a. Administration, Coal Explained: Coal and Environment, https://www.eia.gov/energyexplained/coal/coal-and-the-environment.php. (accessed August 2021).
15. C. f. C. a. E. Solutions, Regulating Power Sector Carbon Emissions https://www.c2es.org/content/regulating-power-sector-carbon emissions/, (accessed August 2021).
16. K. K. Agrawal, S. Jain, A. K. Jain and S. Dahiya, International Journal of Environmental Science and Technology, 2014, 11, 1157-1164.
17. E. S. Sanz-Pérez, C. R. Murdock, S. A. Didas and C. W. Jones, Chem. Rev., 2016, 116, 11840-11876.
18. C. Beuttler, L. Charles and J. Wurzbacher, Frontiers in Climate, 2019, 1.
19. T. Ajayi, J. S. Gomes and A. Bera, Petroleum Science, 2019, 16, 1028-1063.
20. W. J. Schmelz, G. Hochman and K. G. Miller, Interface Focus, 2020, 10, 20190065.
21. B. J. Lee, J. I. Lee, S. Y. Yun, C.-S. Lim and Y.-K. Park, Sustainability, 2020, 12, 6175.
22. N. McQueen, K. V. Gomes, C. McCormick, K. Blumanthal, M. Pisciotta and J. Wilcox, Progress in Energy, 2021, 3, 032001.
23. M. Fasihi, O. Efimova and C. Breyer, J. Cleaner Prod., 2019, 224, 957-980.
24. B. Dutcher, M. Fan and A. G. Russell, ACS Appl. Mater. Interfaces, 2015, 7, 2137-2148.
25. X. Shi, H. Xiao, H. Azarabadi, J. Song, X. Wu, X. Chen and K. S. Lackner, Angew. Chem. Int. Edit., 2020, 59, 6984-7006.
26. P. Bollini, S. A. Didas and C. W. Jones, J. Mater. Chem., 2011, 21, 15100-15120.
27. X. Xu, C. Song, J. M. Andrésen, B. G. Miller and A. W. Scaroni, Microporous Mesoporous Mater., 2003, 62, 29-45.
28. P. J. E. Harlick and A. Sayari, Ind. Eng. Chem. Res., 2007, 46, 446-458.
29. S. Choi, J. H. Drese, P. M. Eisenberger and C. W. Jones, Environ. Sci. Technol., 2011, 45, 2420-2427.
30. W. Chaikittisilp, J. D. Lunn, D. F. Shantz and C. W. Jones, Chem. Eur. J., 2011, 17, 10556-10561.
31. S. Choi, J. H. Drese and C. W. Jones, ChemSusChem, 2009, 2, 796-854.
32. H. Azarabadi and K. S. Lackner, Appl. Energy, 2019, 250, 959-975.
33. A. Goeppert, S. Meth, G. K. S. Prakash and G. A. Olah, Energy Environ. Sci., 2010, 3, 1949-1960.
34. H. T. Kwon, M. A. Sakwa-Novak, S. H. Pang, A. R. Sujan, E. W. Ping and C. W. Jones, Chem. Mat., 2019, 31, 5229-5237.
35. L. A. Darunte, A. D. Oetomo, K. S. Walton, D. S. Sholl and C. W. Jones, ACS Sustainable Chem. Eng., 2016, 4, 5761-5768.
36. L. A. Darunte, K. S. Walton, D. S. Sholl and C. W. Jones, Current Opinion in Chemical Engineering, 2016, 12, 82-90.
37. M. A. Sakwa-Novak and C. W. Jones, ACS Appl. Mater. Interfaces, 2014, 6, 9245-9255.
38. X. Liu, K. Zhou, M. Farndon, E. Meier, L. Stevens, H. Liu and C. Sun, Appl. Energy, 2019, 255, 113643.
39. W. Chaikittisilp, R. Khunsupat, T. T. Chen and C. W. Jones, Ind. Eng. Chem. Res., 2011, 50, 14203-14210.
40. W. Zhang, H. Liu, C. Sun, T. C. Drage and C. E. Snape, Chem. Eng. Sci., 2014, 116, 306-316.
41. X. Shen, H. Du, R. H. Mullins and R. R. Kommalapati, Energy Technology, 2017, 5, 822-833.
42. S. H. Pang, R. P. Lively and C. W. Jones, ChemSusChem, 2018, 11, 2628-2637.
43. M. L. Sarazen, M. A. Sakwa-Novak, E. W. Ping and C. W. Jones, ACS Sustainable Chem. Eng., 2019, 7, 7338-7345.
44. A. R. Sujan, D. R. Kumar, M. Sakwa-Novak, E. W. Ping, B. Hu, S. J. Park and C. W. Jones, ACS Applied Polymer Materials, 2019, 1, 3137-3147.
45. D. R. Kumar, C. Rosu, A. R. Sujan, M. A. Sakwa-Novak, E. W. Ping and C. W. Jones, ACS Sustainable Chem. Eng., 2020, 8, 10971-10982.
46. X. Feng, G. Hu, X. Hu, G. Xie, Y. Xie, J. Lu and M. Luo, Ind. Eng. Chem. Res., 2013, 52, 4221-4228.
47. M. B. Yue, Y. Chun, Y. Cao, X. Dong and J. H. Zhu, Adv. Funct. Mater., 2006, 16, 1717-1722.
48. X. Xu, C. Song, J. M. Andresen, B. G. Miller and A. W. Scaroni, Energy Fuels, 2002, 16, 1463-1469.
49. J. H. Drese, S. Choi, S. A. Didas, P. Bollini, M. L. Gray and C. W. Jones, Microporous Mesoporous Mater., 2012, 151, 231-240.
50. A. Olea, E. S. Sanz-Pérez, A. Arencibia, R. Sanz and G. Calleja, Adsorption, 2013, 19, 589-600.
51. B. Ma, L. Zhuang and S. Chen, Journal of Porous Materials, 2016, 23, 529-537.
52. X. Yan, L. Zhang, Y. Zhang, G. Yang and Z. Yan, Ind. Eng. Chem. Res., 2011, 50, 3220-3226.
53. A. Heydari-Gorji, Y. Yang and A. Sayari, Energy Fuels, 2011, 25, 4206-4210.
54. M. Jahandar Lashaki and A. Sayari, Chem. Eng. J., 2018, 334, 1260-1269.
55. Y. Han, S. S. Lee and J. Y. Ying, Chem. Mat., 2007, 19, 2292-2298.
56. M. Sai Bhargava Reddy, D. Ponnamma, K. K. Sadasivuni, B. Kumar and A. M. Abdullah, RSC Adv., 2021, 11, 12658-12681.
57. G. Rim, T. G. Feric, T. Moore and A.-H. A. Park, Adv. Funct. Mater., 2021, 31, 2010047.
58. X. Xu, M. B. Myers, F. G. Versteeg, B. Pejcic, C. Heath and C. D. Wood, Chem. Commun., 2020, 56, 7151-7154.
59. F. Liu, W. Fu and S. Chen, J. Appl. Polym. Sci., 2020, 137, 48479.
60. C.-J. Yoo, P. Narayanan and C. W. Jones, J. Mater. Chem. A, 2019, 7, 19513-19521.
61. R. Sanz, G. Calleja, A. Arencibia and E. S. Sanz-Pérez, Appl. Surf. Sci., 2010, 256, 5323-5328.
62. A. Holewinski, M. A. Sakwa-Novak and C. W. Jones, J. Am. Chem. Soc., 2015, 137, 11749-11759.
63. A. Sayari, Y. Belmabkhout and E. Da'na, Langmuir, 2012, 28, 4241-4247.
64. J. M. Kolle, M. Fayaz and A. Sayari, Chem. Rev., 2021, 121, 7280-7345.
65. P. G. de Gennes, ed. I. Cornell University, Cornell University, Ithaca, 1979.
66. M. Doi, Edwards, S. F., The Theory of Polymer Solutions, Clarendon, Oxford, 1986.
67. B.-Y. Ha and Y. Jung, Soft Matter, 2015, 11, 2333-2352.
68. J. M. Polson and Q. Zhu, Phys. Rev. E, 2021, 103, 012501.
69. S. Chandran, J. Baschnagel, D. Cangialosi, K. Fukao, E. Glynos, L. M. C. Janssen, M. Müller, M. Muthukumar, U. Steiner, J. Xu, S. Napolitano and G. Reiter, Macromolecules, 2019, 52, 7146-7156.
70. K. I. Kim, R. Lawler, H. J. Moon, P. Narayanan, M. A. Sakwa-Novak, C. W. Jones and S. S. Jang, ACS Omega, 2021, 6, 3390-3398.
71. C. Rosu, S. H. Pang, A. R. Sujan, M. A. Sakwa-Novak, E. W. Ping and C. W. Jones, ACS Appl. Mater. Interfaces, 2020, 12, 38085-38097.

### Supplementary Information to Example 1

TABLE 4
Sample Name, Organic Content, N Content, Surface Area,
Pore Volume and Pore Filling for SPISS Samples

| | Organic Content | N Content | Surface area | Pore volume | Pore |
|---|---|---|---|---|---|
| Sample | (EA), (%) | (mmol) | (BET) (m2/g) | (cm3/g) | filling/% |
| SBA-15 | — | — | 796.5 | 1.08 | — |
| 40% bPEI-SBA-15 precursor to 50% | 35.30 | 13.0 | 89 | 0.17 | 83.7 |
| LPPI-bPEI-SBA-15 SBD | | | | | |
| 50% LPPI-bPEI-SBA-15 SBD | 47.5 | 18.2 | 36 | 0.07 | 93.5 |
| 40% bPEI-SBA-15 precursor to 50% | 42 | 16.8 | 88 | 0.17 | 83.7 |
| bPEI-SBA-15 SBD | | | | | |
| 50% bPEI-SBA-15 SBD | 46.5 | 20.5 | 11 | 0.02 | 98.0 |
| 40% bPEI-SBA-15 precursor to 50% | 39.0 | 14.5 | 96 | 0.18 | 83.3 |
| LPPI-bPEI-SBA-15 SBL | | | | | |
| 50% LPPI-bPEI-SBA-15 SBL | 42.5 | 16.0 | 39.5 | 0.07 | 93.5 |
| 40% bPEI-SBA-15 precursor to 50% | 40.5 | 16.0 | 81 | 0.16 | 85.0 |
| bPEI-SBA-15 SBL | | | | | |
| 50% bPEI-SBA-15 SBL | 49.0 | 22.4 | 6.4 | 0.02 | 98.0 |

TABLE 5
Sample Name and CO₂ Stream Concentration/Uptake
for the SPISS Samples after 12 hr adsorption in corresponding
CO₂ stream at 35° C.

| | CO₂ Stream Concentration/Uptake | | | |
|---|---|---|---|---|
| | 10% | | 400 ppm | |
| Sample | CC | AE | CC | AE |
| 50% LPPI-bPEI-SBA-15 | 3.40 | 0.19 | 2.55 | 0.14 |
| SBD | | | | |
| 40% bPEI-SBA-15 | 2.97 | 0.23 | 1.85 | 0.14 |
| precursor to 50% LPPI- | | | | |
| bPEI-SBA-15 SBD | | | | |
| 50% bPEI-SBA-15 SBD | 2.94 | 0.14 | 2.62 | 0.13 |
| 40% bPEI-SBA-15 | 3.17 | 0.19 | 2.56 | 0.13 |
| precursor to 50% bPEI- | | | | |
| SBA-15 SBD | | | | |
| 50% LPPI-bPEI-SBA-15 | 3.24 | 0.20 | 2.55 | 0.16 |
| SBL | | | | |
| 40% bPEI precursor to | 3.4 | 0.23 | 2.23 | 0.15 |
| 50% LPPI-bPEI-SBA-15 | | | | |
| SBL | | | | |
| 50% bPEI-SBA-15 SBL | 3.47 | 0.15 | 2.72 | 0.12 |
| 40% bPEI precursor to | 2.81 | 0.18 | 2.30 | 0.14 |
| 50% bPEI-SBA-15 SBL | | | | |

*CC- CO₂ Capacity (mmol CO₂/g SiO₂) and AE-amine Efficiency (mmol CO₂/mmol N)

TABLE 6
Sample Name and CO₂ Stream Concentration and Uptake for the SPISS
Samples after TSA cycling with 1 hr adsorption at 35° C. and 10
min desorption at 90° C. with corresponding CO₂ stream

| | CO₂ Stream Concentration and Uptake | | | |
|---|---|---|---|---|
| | 10% CO₂ | | 400 ppm CO₂ | |
| Sample | CC | AE | CC | AE |
| 50% LPPI-bPEI-SBA-15 SBD | 2.43 | 0.13 | 2.00 | 0.11 |
| 40% bPEI precursor to 50% | 2.43 | 0.19 | 1.55 | 0.12 |
| LPPI-bPEI-SBA-15 SBD | | | | |
| 50% bPEI-SBA-15 SBD | 2.42 | 0.12 | 2.45 | 0.12 |
| 40% bPEI precursor to 50% | 2.71 | 0.16 | 2.00 | 0.12 |
| bPEI-SBA-15 SBD | | | | |
| 50% LPPI-bPEI-SBA-15 SBL | 2.64 | 0.16 | 1.80 | 0.11 |
| 40% bPEI precursor to 50% | 2.65 | 0.17 | 1.80 | 0.14 |
| LPPI-bPEI-SBA-15 SBL | | | | |
| 50% bPEI-SBA-15 SBL | 2.85 | 0.13 | 2.60 | 0.12 |
| 40% bPEI precursor to 50% | 2.63 | 0.16 | 1.67 | 0.10 |
| bPEI-SBA-15 SBL | | | | |

### Example 2

Preparation of improved CO₂-philic phase sorbents containing polypropylenimine (PPI) and polyethylenimine (PEI) Branched polyethylenimine (PEI), MW 800 was purchased from Sigma Aldrich. Polypropylenimine (PPI), MW 1200, was synthesized and sourced from a partner manufacturer Celares. Samples for each of titania and alumina were made. The PEI was dissolved in a solution of methanol, after which the PPI was added. PPI was added in ratios corresponding to 0.1 and 0.75 mol PPI per mol of N present in PEI. Separately, a mesoporous titania or alumina was dispersed in methanol and mixed until homogeneous. Then, the PEI/PPI mixture was pipetted into the titania or alumina/methanol dispersion. After stirring for >3 h the solvent was removed by rotary evaporation and subsequent drying in a vacuum oven at 100° C. Mass ratios of the titania or alumina and PEI/PPI were controlled such as to achieve 50-70% filling of the mesopores of the mesoporous titania or alumina with PEI/PPI mixture. The resultant composite sorbents were of a powdery consistency.

Chemical Characterization of improved CO₂-philic phase sorbents containing polypropylenimine (PPI) and polyethylenimine (PEI)

Chemical characterization was carried out to confirm the properties of the improved CO₂-philic phases. TGA burnoff experiments were carried out on sorbents comprised of the improved CO₂-philic phases to characterize the total quantity of organic present in the sorbent. Samples were heated under diluted air to 900° C. and their mass loss tracked. Total organic content was taken as the mass loss over that temperature interval, after removing the contribution of CO₂ and H₂O lost at lower temperatures.

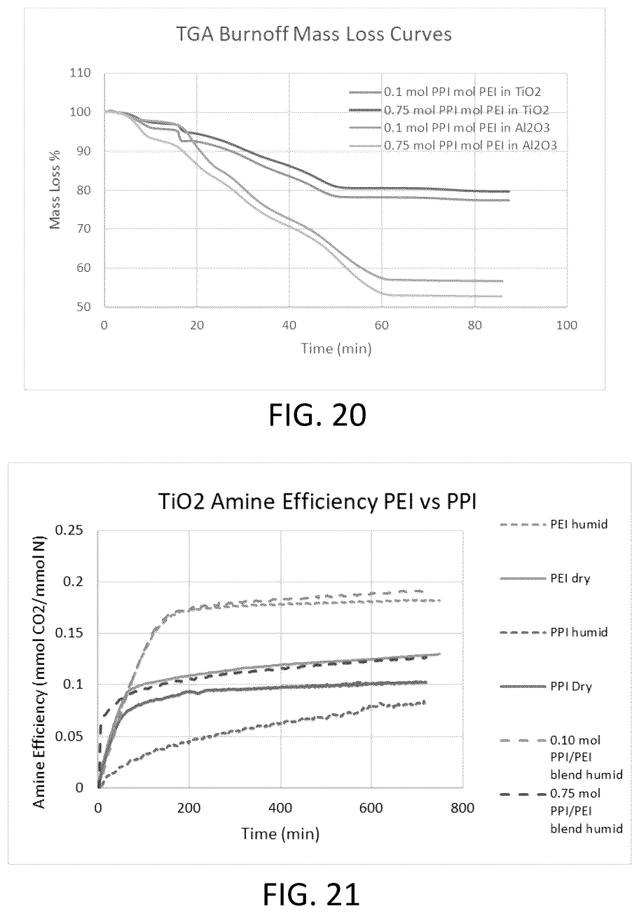

FIG. 20 shows the transient mass loss curve during exposure of sorbents with CO₂-philic phases including PPI/PEI blends at varied loadings and in different porous supports to diluted air while ramping the temperature from room temperature to 900° C. The figures show that the PPI/PEI sorbents lose substantial mass during the experiment, as the organic fractions of the materials burn off from the oxidative conditions. The sorbents created using porous alumina have greater mesopore volume and therefore have a higher mass ratio of PPI/PEI due to the fact that a larger degree of CO₂-philic phase is incorporated into the pores to achieve the desired pore fill of 50-70%.

### Testing in CO₂ Adsorption Processes

Sorbents created with improved CO₂-philic phases were tested for CO₂ adsorption in a TGA under 400 ppm CO₂ at 30° C. in dry and humid conditions to simulate the gas contacting step of a Direct Air Capture process. For dry experiments, the sorbents were first treated in N₂ at 100° C. to desorb any bound H₂O and CO₂ before being equilibrated at 30° C. under N₂. Then, the gas concentration was switched isothermally to contain 400 ppm CO₂ balanced by N₂ and the mass change was recorded. Under these moisture free conditions, the mass gain of the material corresponds to the adsorption of CO₂ and therefore can be used to measure the total quantity and rate of CO₂ adsorption onto the materials. For humid experiments, the sorbents were first treated in N₂ at 100° C. to desorb any bound H₂O and CO₂ before being equilibrated at 30° C. under humidified N₂. Then, the gas concentration was switched isothermally to contain humidified 400 ppm CO₂ balanced by N₂ and the mass change was recorded. To humidify the N₂ and 400 ppm CO₂ balance N₂ gases, the gas was saturated with water vapor at a dew point of 10° C. by sparging the gas stream in a water bath held at 10° C. Under these humid conditions, it is assumed that no additional water is adsorbed between switching from a humidified N₂ stream to a humidified CO₂ and N₂ stream, and thus the mass gain of the material corresponds to the adsorption of CO₂ and therefore can be used to measure the total quantity and rate of CO₂ adsorption onto the materials.

Various improved sorbents were characterized for CO₂ adsorption using these methods and compared to the baseline PEI and PPI based sorbents.

The sorbents were evaluated on two bases, i) CO₂ capacity, mmol of CO₂ adsorbed per mmol of sorbent present, and ii) amine efficiency, mmol of CO₂ adsorbed per mmol of N present. The former unit of performance is useful to show bulk sorbent performance, and the second unit of performance is useful to evaluate the performance of the amine polymer itself and takes into account changes to the bulk composition of the sorbent.

FIG. 21 illustrates transient mass change profiles from TGA CO₂ uptake experiments at 400 ppm CO₂ (DAC conditions) utilizing improved sorbents containing PPI/PEI blends at different mole ratios in a mesoporous titania. Data for a sorbent utilizing PEI and PPI are shown for reference as well. Data are reported as amine efficiency (mmol CO₂/mmol N) to take into account the variation in amine loading between different sorbents.

FIG. 21 shows transient TGA uptake curves under DAC conditions for sorbents created with improved CO₂-philic phases utilizing PPI/PEI blends compared to that of PEI and PPI. Each of the sorbents are able to adsorb CO₂ at the ultra-dilute conditions of 400 ppm, with varying degrees of amine efficiency. The 0.1 mol PPI/PEI sorbent has a comparable amine efficiency to PEI under humid conditions, while the 0.75 mol PPI/PEI sorbent has a lower amine efficiency. Both PPI/PEI blend materials have higher amine efficiencies in humid conditions compared to a PPI sorbent.

### Testing of Oxidative Stability

The oxidative stability of materials can be probed in several ways.

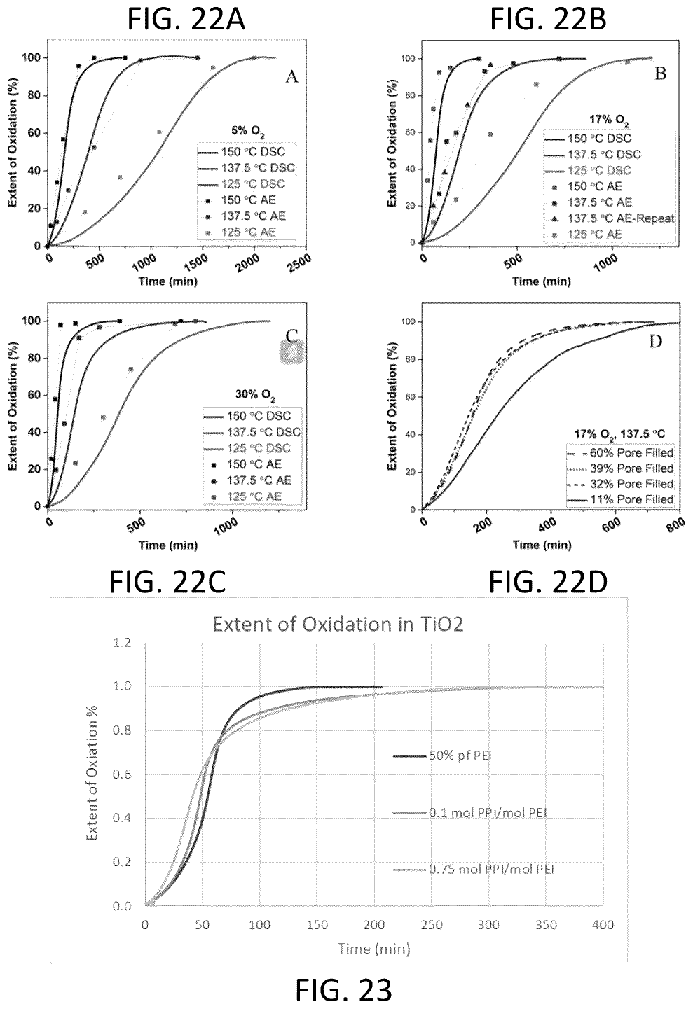

In this study, the oxidative stability of the sorbents was evaluated by tracking the heat flow evolved from the materials using a DSC during exposure to isothermal oxidative conditions. Here, the sorbents were first treated in inert gas at 100° C. to desorb any bound H₂O and CO₂ before being equilibrated at 137.5° C. under inert gas for 60 minutes. The gas was then isothermally switched to a 17% O₂ mixture and held until the reaction finished. This isothermal, oxidative environment was maintained for a specific amount of time to measure the heat flow and mass loss. To prevent any further oxidation, the sample was then cooled under N₂ to room temperature. During these experiments, for each oxidative condition, the DSC measures the incremental heat flux, which increases, levels out, and then decreases to zero. The oxidation was considered complete when the integrated heat flow over 10 min changed less than +0.01% of the total integrated heat. To determine the extent of oxidation as a function of time, DSC data were converted from the base unit of mW/mg sorbent to W/gPEI using the PEI loading measured by TGA burnoff. DSC data were corrected for drift by applying an offset, determined by the heat flow value when the DSC curve approached a horizontal line. The total heat evolved was calculated by integrating heat flow over time. The extent of oxidation from DSC was calculated by dividing the integral heat flow curve by the total heat evolved. This method has been previously calibrated with the loss in amine efficiency as being a method of tracking the chemical reaction rate of oxidative degradation in-situ and is shown in FIG. 22. Further details on this method and its validation are discussed in the following papers: Nezam et al, ACS Sustainable Chem. Eng., 2021, 9, 8477-8486, and Racicot et al, J. Phys. Chem. C, 2022, 126, 8807-8816, which is incorporated herein by reference.

Evaluating the oxidative stability of materials in environments that contain oxygen and CO₂ is useful due to the fact that during regeneration processes, desorbed CO₂ is present at different concentrations in addition to oxygen at elevated temperatures and can impact the stability of the material. Separately, evaluating the oxidative stability of materials with oxygen only (air) is a useful way to evaluate the shelf life of a material when it is stored at ambient conditions.

FIG. 23 shows oxidation curves in the presence of air only for CO₂ sorbents created with varied PPI/PEI blend ratios as well as a PEI sorbent supported in mesoporous titania. The figure shows that the initial rate of oxidation for PPI/PEI blend sorbents is higher than that of PEI, however the time to reach 100% oxidation is delayed for both 0.1 and 0.75 mol PPI/mol PEI sorbents as compared to PEI.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1 percent to about 5 percent” should be interpreted to include not only the explicitly recited concentration of about 0.1 weight percent to about 5 weight percent but also include individual concentrations (e.g., 1 percent, 2 percent, 3 percent, and 4 percent) and the sub-ranges (e.g., 0.5 percent, 1.1 percent, 2.2 percent, 3.3 percent, and 4.4 percent) within the indicated range. The term “about” can include traditional rounding according to significant figures of the numerical value. In addition, the phrase “about ‘x’ to ‘y’” includes “about ‘x’ to about ‘y’”.

Many variations and modifications may be made to the above-described aspects. All such modifications and variations are intended to be included herein within the scope of this disclosure and protected by the following claims.

What is claimed is:

1. A sorbent comprising:
a CO₂-philic phase and a support, wherein the CO₂-philic phase includes a first type of CO₂ binding molecule and a second type of CO₂ binding molecule, wherein the first type of CO₂ binding molecule is polypropylenimine, and the second type of CO₂ binding molecule is polyethylenimine.

2. The sorbent of claim 1, wherein the first type of CO₂ binding molecule and the second type of CO₂ binding molecule are independently selected from an amine polymer.

3. The sorbent of claim 2, where the amine polymer is branched, hyperbranched, dendritic, or linear.

4. The sorbent of claim 1, wherein the ratio of the amount of the first type of CO₂ binding molecule to the second type of CO₂ binding molecule is 0.01 to 0.5 mole of the first type of CO₂ binding molecule to mole of the second type of CO₂ binding molecule.

5. The sorbent of claim 1, wherein the CO₂-philic phase homogeneous.

6. The sorbent of claim 1, wherein the CO₂-philic phase heterogeneous.

7. The sorbent of claim 1, wherein the first type of CO₂ binding molecule, the second type of CO₂ binding molecule, or both are physically impregnated into pores of the support.

8. The sorbent of claim 7, wherein both are physically impregnated into pores of the support.

9. The sorbent of claim 1, wherein the first type of CO₂ binding molecule, the second type of CO₂ binding molecule, or both are physically impregnated onto the surface of the support.

10. The sorbent of claim 1, wherein the first type of CO₂ binding molecule and the second type of CO₂ binding molecule are both are physically impregnated onto the surface of the support.

11. The sorbent of claim 1, wherein the first type of CO₂ binding molecule, the second type of CO₂ binding molecule, or both are covalently bonded to the surface of the support.

12. The sorbent of claim 1, wherein one of the first type of CO₂ binding molecule and the second type of CO₂ binding molecule is covalently bonded to the surface of the support.

13. The sorbent of claim 1, wherein both the first type of CO₂ binding molecule and the second type of CO₂ binding molecule are covalently bonded to the surface of the support.

14. The sorbent of claim 1, wherein the support is ceramic, metal, metal oxide, plastic, cellulose, carbon, a zeolite, a metal organic framework (MOF), a porous organic framework (POF), a covenant organic framework (COF), a polymer of intrinsic microporosity (PIM), a polymer, a fibrous cellulose, fiberglass, or boron-nitride fiber.

15. A contactor, comprising a structure and the sorbent of claim 1.

16. The contactor of claim 15, wherein the structure is selected from a honeycomb, a laminate sheet, a foam, fibers, gyroids, powder trays, pellets, powder, or a combination of these.

17. A system for capturing CO₂ from a gas, optionally the gas is ambient air, comprising:
a first device configured to introduce the gas to the sorbent or contactor of claim 1 to bind CO₂ to the sorbent;
a second device configured to heat the sorbent containing bound CO₂ to at least a first temperature to release the CO₂, wherein after being heated the sorbent is regenerated so it absorbs CO₂ from the gas; and
a third device configured to collect the released CO₂.

18. The system of claim 17, wherein the sorbent is in the form of a honeycomb, a laminate sheet, fibers, a minimal surface solid, a foam, pellets, powder trays, a combination thereof.

19. The system of claim 17, wherein the honeycomb has an open face area of between 0.3-0.95, wherein the gas approaches the honeycomb at a velocity of between 0.25-10 m/s.

20. The system of claim 17, wherein the system is configured to operate to remove CO₂ from ambient air, where the ambient air has a low concentration of CO₂.
